(19) United States
(12) Patent Application Publication
(10) Pub. No.: US 2016/0365693 A1
(43) Pub. Date: Dec. 15, 2016

(54) Inspection System Using 193nm Laser

(71) Applicant: KLA-Tencor Corporation, Milpitas, CA (US)

(72) Inventors: Yung-Ho Alex Chuang, Cupertino, CA (US); J. Joseph Armstrong, Fremont, CA (US); Vladimir Dribinski, Livermore, CA (US); John Fielden, Los Altos, CA (US)

(21) Appl. No.: 15/249,096

(22) Filed: Aug. 26, 2016

Related U.S. Application Data
(62) Division of application No. 13/797,939, filed on Mar. 12, 2013.
(60) Provisional application No. 61/650,349, filed on May 22, 2012.

(51) Int. Cl. H01S 3/00; H01S 3/23; G01N 21/956; H01S 3/16; G01N 21/88

(52) U.S. Cl. CPC H01S 3/0092; H01S 3/1611; G01N 21/8806; G01N 21/956; H01S 3/2383; H01S 3/2308; G01N 2021/95676

(57) ABSTRACT

Improved inspection systems utilize laser systems and associated techniques to generate an ultra-violet (UV) wavelength of approximately 193.368 nm from a fundamental vacuum wavelength near 1063.5 nm. Preferred embodiments separate out an unconsumed portion of an input wavelength to at least one stage and redirect that unconsumed portion for use in another stage. The improved laser systems and associated techniques result in less expensive, longer life lasers than those currently being used in the industry. These laser systems can be constructed with readily-available, relatively inexpensive components.

### RELATED APPLICATIONS

The present application is a divisional of U.S. patent application Ser. No. 13/797,939, entitled “SOLID-STATE LASER AND INSPECTION SYSTEM USING 193 nm LASER” which claims priority to U.S. Provisional Application 61/650,349, entitled “Solid-State 193 nm Laser And An Inspection System Using A Solid-State 193 nm Laser” and filed May 22, 2012, which is incorporated by reference herein.

### BACKGROUND OF THE DISCLOSURE

The present disclosure relates to a laser system that generates light near 193 nm and is suitable for use in photomask, reticle, or wafer inspection.

### RELATED ART

The integrated circuit industry requires inspection tools with increasingly higher resolution to resolve ever smaller features of integrated circuits, photomasks, solar cells, charge coupled devices etc., as well as detect defects whose sizes are of the order of, or smaller than, feature sizes. Short wavelength light sources, e.g. sources generating light under 200 nm, can provide such resolution. However, the light sources capable of providing such short wavelength light are substantially limited to excimer lasers and a small number of solid-state and fiber lasers. Unfortunately, each of these lasers has significant disadvantages.

An excimer laser generates an ultraviolet light, which is commonly used in the production of integrated circuits. An excimer laser typically uses a combination of a noble gas and a reactive gas under high pressure conditions to generate the ultraviolet light. A conventional excimer laser generating 193 nm wavelength light, which is increasingly a highly desirable wavelength in the integrated circuit industry, uses argon (as the noble gas) and fluorine (as the reactive gas). Unfortunately, fluorine is toxic and corrosive, thereby resulting in high cost of ownership. Moreover, such lasers are not well suited to inspection applications because of their low repetition rate (typically from about 100 Hz to several kHz) and very high peak power that would result in damage of samples during inspection.

A small number of solid state and fiber based lasers producing sub-200 nm output are known in the art. Unfortunately, most of these lasers have very low power output (e.g. under 60 mW), or very complex design, such as two different fundamental sources or eighth harmonic generation, both of which are complex, unstable, expensive and/or commercially unattractive.

Therefore, a need arises for a laser capable of generating 193 nm light yet overcoming the above disadvantages.

### SUMMARY OF THE DISCLOSURE

In accordance with the improved laser systems and associated techniques described herein, an ultra-violet (UV) wavelength of approximately 193.368 nm can be generated from a fundamental vacuum wavelength near 1064 nm. The described laser systems and associated techniques result in less expensive, longer life lasers than those currently being used in the industry. These laser systems can be constructed with readily-available, relatively inexpensive components. Thus, the described laser systems and associated techniques can provide significantly better cost of ownership compared to UV lasers currently in the market.

A laser system for generating approximately 193.368 nm wavelength light is described. This laser system can include a fundamental laser configured to generate a fundamental frequency corresponding to a wavelength of approximately 1064 nm. The fundamental frequency is herein referred to as co. An optical parametric (OP) module (such as an optical parametric oscillator or an optical parametric amplifier) is configured to down convert the fundamental frequency and to generate an OP output, which is a half harmonic of the fundamental frequency. A fifth harmonic generator module is configured to use an unconsumed fundamental frequency of the OP module to generate a 5^{th} harmonic frequency. A frequency mixing module can combine the 5^{th} harmonic frequency and the OP output to generate a laser output with the approximately 193.368 nm wavelength.

Another laser system for generating approximately 193.368 nm wavelength light is described. This laser system can include a fundamental laser configured to generate a fundamental frequency corresponding to a wavelength of approximately 1064 nm. A fifth harmonic generator module is configured to use the fundamental frequency to generate a 5^{th} harmonic frequency. An OP module is configured to down convert an unconsumed fundamental frequency of the fifth harmonic generator module to generate an OP output. A frequency mixing module can combine the 5^{th} harmonic frequency and the OP output to generate a laser output with the approximately 193.368 nm wavelength.

Yet another laser system for generating approximately 193.368 nm wavelength light is described. This laser system can include a fundamental laser configured to generate a fundamental frequency corresponding to a wavelength of approximately 1064 nm. A second harmonic generator module is configured to double a portion of the fundamental frequency to generate a 2^{nd} harmonic frequency. A fifth harmonic module is configured to double the second harmonic frequency and combine a resulting frequency with an unconsumed fundamental frequency of the second harmonic generator module to generate a fifth harmonic frequency. An OP module is configured to down convert an unconsumed portion of the 2^{nd} harmonic frequency from the fifth harmonic generator module to generate an OP signal of approximately 1.5ω and an OP idler at approximately 0.5ω, wherein ω is the fundamental frequency. A frequency mixing module can combine the 5^{th} harmonic frequency and the OP idler to generate a laser output of the approximately 193.368 nm wavelength.

Yet another laser system for generating approximately 193.368 nm wavelength light is described. This laser system can include a fundamental laser configured to generate a fundamental frequency of approximately 1064 nm. A second harmonic generator module is configured to double the fundamental frequency to generate a 2^{nd} harmonic frequency. An OP module is configured to down convert a portion of the 2^{nd} harmonic frequency to generate an OP signal of approximately 1.5ω and an OP idler at approximately 0.5ω, wherein ω is the fundamental frequency. A fourth harmonic generator module is configured to double another portion of the 2^{nd} harmonic frequency to generate a 4^{th} harmonic frequency. A frequency mixing module is configured to combine the fourth harmonic frequency and the OP signal to generate a laser output of the approximately 193.368 nm wavelength light.

Yet another laser system for generating approximately 193.368 nm wavelength light is described. This laser system can include a fundamental laser configured to generate a fundamental frequency of approximately 1064 nm. An OP module is configured to down convert a portion of the fundamental frequency and to generate an OP output, which is approximately a half harmonic of the fundamental frequency. A second harmonic generator module is configured to double a portion of the fundamental frequency to generate a 2^{nd} harmonic frequency. A fourth harmonic generator module is configured to double the 2^{nd} harmonic frequency to generate a 4^{th} harmonic frequency. A first frequency mixing module is configured to receive the 4^{th} harmonic frequency and the OP output to generate a 4.5 harmonic frequency. A second frequency mixing module is configured to combine an unconsumed portion of the fundamental frequency of the second harmonic generator and the 4.5 harmonic frequency to generate a laser output of the approximately 193.368 nm wavelength light.

In some of the laser system embodiments, the fundamental laser may comprise a Q-switched laser, a mode-locked laser, or a continuous wave (CW) laser. In some embodiments, the lasing medium of the fundamental laser may include an ytterbium-doped fiber, a neodymium-doped yttrium aluminum garnate crystal, a neodymium-doped yttrium orthovanadate crystal, or a neodymium doped mixture of gadolinium vanadate and yttrium vanadate.

In one embodiment, the OP module operates degenerately, i.e. there is only a signal, which is at a frequency of 0.5ω. In those embodiments using degenerate down conversion, for maximum efficiency, it is preferred to use type I down conversion (i.e. the two photons generated have the same polarization), when permitted by the non-linear crystal properties and the wavelength. In another embodiment, the OP module generates a signal and an idler at slightly different frequencies where one is slightly higher in frequency than 0.5ω and the other is slightly lower in frequency than 0.5ω. For example if the fundamental laser generates a wavelength of 1064.4 nm, then the signal frequency will correspond to a wavelength of 2109.7 nm and the idler frequency will correspond to a wavelength of 2148.3 nm.

In one embodiment, the OP module can include an OP oscillator (OPO). In another embodiment, the OP module can include an OP amplifier (OPA) and can include a seed laser that generates light of the desired signal wavelength and bandwidth. The seed laser may comprise, for example, a laser diode or a fiber laser. In preferred embodiments, the seed laser is stabilized by a grating, by distributed feedback, by a volume Bragg grating, or by other means to accurately maintain the desired wavelength and bandwidth.

Note that the seed laser (or the OPO wavelength in an OPO-based OP module) has to be selected or adjusted in order to achieve the desired laser system output wavelength near 193.368 nm based on the wavelength of the fundamental laser. For example, if the desired wavelength is 193.368 nm and the center wavelength of the fundamental laser is 1064.4 nm, then the seed laser needs to generate 2109.7 nm in those embodiments using a signal frequency of approximately 0.5ω. Because individual fundamental lasers, even when using the same lasing material, can vary from one to another by a few tenths of a nm in center wavelength (depending on factors including operating temperature and variations in material composition), in some preferred embodiments, the seed laser wavelength is adjustable. In some embodiments, the laser system output wavelength may need to be adjustable by a few pm, which can be accomplished by adjusting the seed or OPO wavelength by a few nm.

In one embodiment, the fifth harmonic module can include second, fourth, and fifth harmonic generators. The second harmonic generator is configured to double the fundamental frequency to generate a 2^{nd} harmonic frequency. The fourth harmonic generator is configured to double the 2^{nd} harmonic frequency to generate a 4^{th} harmonic frequency. The 5^{th} harmonic generator is configured to combine the 4^{th} harmonic frequency and an unconsumed portion of the fundamental of the second harmonic generator to generate a 5^{th} harmonic frequency.

In another embodiment, the fifth harmonic module can include second, third, and fifth harmonic generators. The second harmonic generator is configured to double the fundamental frequency to generate a 2^{nd} harmonic frequency. The third harmonic generator is configured to combine the 2^{nd} harmonic frequency and an unconsumed portion of the fundamental of the second harmonic generator to generate a 3^{rd} harmonic frequency. The fifth harmonic generator is configured to combine the 3^{rd} harmonic frequency and an unconsumed portion of the 2^{nd} harmonic frequency of the third harmonic generator to generate a 5^{th} harmonic frequency.

In yet another embodiment, the fifth harmonic generator module can include fourth and fifth harmonic generators. The fourth harmonic generator is configured to double the 2^{nd} harmonic frequency to generate a 4^{th} harmonic frequency. The fifth harmonic generator is configured to receive the 4^{th} harmonic frequency and a portion of the fundamental frequency to generate the 5^{th} harmonic frequency.

In yet another embodiment, the fifth harmonic generator module can include third and fifth harmonic generators. The third harmonic generator is configured to combine the second harmonic frequency and the fundamental frequency to generate a 3^{rd} harmonic frequency. The fifth harmonic generator is configured to combine the 3^{rd} harmonic and an unconsumed 2^{nd} harmonic frequency of the third harmonic generator to generate the 5^{th} harmonic frequency.

A method of generating approximately 193.368 nm wavelength light is described. In this method, a fundamental frequency of approximately 1064 nm can be generated. This fundamental frequency can be down converted to generate an OP output, which is a half harmonic of the fundamental frequency. An unconsumed portion of the fundamental frequency of the down converting can be used to generate a 5^{th} harmonic frequency. The 5^{th} harmonic frequency and the signal frequency can be combined to generate the approximately 193.368 nm wavelength light.

Another method of generating approximately 193.368 nm wavelength light is described. In this method, a fundamental frequency of approximately 1064 nm can be generated. This fundamental frequency can be used to generate a fifth harmonic frequency. An unconsumed fundamental frequency can be down converted to generate an OP output, which is a half harmonic of the fundamental frequency. The fifth harmonic frequency and the OP output can be combined to generate the approximately 193.368 nm wavelength light.

Another method of generating approximately 193.368 nm wavelength light is described. In this method, a fundamental frequency of approximately 1064 nm can be generated. The fundamental frequency can be doubled to generate a 2^{nd} harmonic frequency. A portion of the 2^{nd} harmonic frequency can be down converted to generate an OP signal of approximately 1.5ω and an OP idler at approximately 0.5ω, wherein ω is the fundamental frequency. An unconsumed portion of the fundamental frequency of the doubling and an unconsumed portion of the 2^{nd} harmonic frequency of the down converting can be used to generate a 5^{th} harmonic frequency. The 5^{th} harmonic frequency and the OP idler can be combined to generate the approximately 193.368 nm.

Yet another method of generating approximately 193.368 nm wavelength light is described. In this method, a fundamental frequency of approximately 1064 nm is generated. The fundamental frequency can be doubled to generate a 2^{nd} harmonic frequency. A portion of the 2^{nd} harmonic frequency can be down converted to generate an OP signal of approximately 1.5w and an OP idler at approximately 0.5ω, wherein ω is the fundamental frequency. Another portion of the second harmonic frequency can be doubled to generate a 4^{th} harmonic frequency. The 4^{th} harmonic frequency and the OP signal can be combined to generate the approximately 193.368 nm wavelength light.

Yet another method of generating approximately 193.368 nm wavelength light is described. In this method, a fundamental frequency of approximately 1064 nm is generated. A portion of the fundamental frequency can be down converted to generate an OP output of approximately 0.5ω. Another portion of the fundamental frequency can be doubled to generate a 2^{nd} harmonic frequency. The 2^{nd} harmonic frequency can be doubled to generate a 4^{th} harmonic frequency. The 4^{th} harmonic frequency and the OP output can be combined to generate an approximately 4.5 harmonic frequency. The approximately 4.5 harmonic frequency and yet another portion of the fundamental can be combined to generate the approximately 193.368 nm wavelength light.

Various systems for inspecting samples are described. These systems can include a laser system for generating an output beam of radiation at approximately 193.368 nm. The laser system can include a fundamental laser for generating a fundamental frequency having a corresponding wavelength of approximately 1064 nm, an OP module for down converting the fundamental frequency or a harmonic frequency to generate an OP output, and a plurality of harmonic generators and frequency mixing modules for generating a plurality of frequencies. The fundamental frequency, the plurality of frequencies, and the OP output can be used to generate the approximately 193.368 nm radiation. The laser system is optimized to use at least one unconsumed frequency. The systems can further include means for focusing the output beam on the sample and means for collecting scattered or reflected light from the sample.

An optical inspection system for inspecting a surface of a photomask, reticle, or semiconductor wafer for defects is described. This system can include a light source for emitting an incident light beam along an optical axis, the light source including a laser system as described herein. This laser system can include a fundamental laser for generating a fundamental frequency of approximately 1064 nm, an optical parametric (OP) module for down converting the fundamental frequency or a harmonic frequency to generate an OP output, and a plurality of harmonic generators and frequency mixing modules for generating a plurality of frequencies. The fundamental frequency, the plurality of frequencies, and the OP output can be used to generate the approximately 193.368 nm wavelength light. The laser system is optimized to use at least one unconsumed frequency. An optical system disposed along the optical axis and including a plurality of optical components is configured to separate the incident light beam into individual light beams, all of the individual light beams forming scanning spots at different locations on a surface of the photomask, reticle or semiconductor wafer. The scanning spots are configured to simultaneously scan the surface. A transmitted light detector arrangement can include transmitted light detectors that correspond to individual ones of a plurality of transmitted light beams caused by the intersection of the individual light beams with the surface of the reticle mask, or semiconductor wafer. The transmitted light detectors are arranged for sensing a light intensity of transmitted light. A reflected light detector arrangement can include reflected light detectors that correspond to individual ones of a plurality of reflected light beams caused by the intersection of the individual light beams with the surface of the reticle mask, or semiconductor wafer. The reflected light detectors are arranged for sensing a light intensity of reflected light.

Another optical inspection system for inspecting a surface of a photomask, reticle, or semiconductor wafer for defects is described. This inspection system simultaneously illuminates and detects two channels of signal or image. Both channels are simultaneously detected on the same sensor. The two channels may comprise reflected and transmitted intensity when the inspected object is transparent (for example a reticle or photomask), or may comprise two different illumination modes, such as angles of incidence, polarization states, wavelength ranges or some combination thereof.

An inspection system for inspecting a surface of a sample is also described. This inspection system includes an illumination subsystem configured to produce a plurality of channels of light, each channel of light produced having differing characteristics from at least one other channel of light energy. The illumination subsystem includes a light source for emitting an incident light beam of approximately 193.368 nm wavelength. The light source includes a fundamental laser for generating a fundamental frequency of approximately 1064 nm, an OP module for down converting the fundamental frequency or a harmonic frequency to generate an OP output, and a plurality of harmonic generators and frequency mixing modules for generating a plurality of frequencies, wherein the fundamental frequency, the plurality of frequencies, and the OP output are used to generate the approximately 193.368 nm wavelength light. The light source is optimized to use at least one unconsumed frequency. Optics are configured to receive the plurality of channels of light and combine the plurality of channels of light energy into a spatially separated combined light beam and direct the spatially separated combined light beam toward the sample. A data acquisition subsystem includes at least one detector configured to detect reflected light from the sample. The data acquisition subsystem can be configured to separate the reflected light into a plurality of received channels corresponding to the plurality of channels of light.

A catadioptric inspection system is also described. This system includes an ultraviolet (UV) light source for generating UV light, a plurality of imaging sub-sections, and a folding mirror group. The UV light source includes a fundamental laser for generating a fundamental frequency of approximately 1064 nm, an OP module for down converting the fundamental frequency or a harmonic frequency to generate an OP output, and a plurality of harmonic generators and frequency mixing modules for generating a plurality of frequencies, wherein the fundamental frequency, the plurality of frequencies, and the OP output are used to generate approximately 193.368 nm wavelength light. The UV light source is optimized to use at least one unconsumed frequency. Each sub-section of the plurality of imaging sub-sections can includes a focusing lens group, a field lens group, a catadioptric lens group, and a zooming tube lens group.

The focusing lens group can include a plurality of lens elements disposed along an optical path of the system to focus the UV light at an intermediate image within the system. The focusing lens group can also simultaneously provide correction of monochromatic aberrations and chromatic variation of aberrations over a wavelength band including at least one wavelength in an ultraviolet range. The focusing lens group can further include a beam splitter positioned to receive the UV light.

The field lens group can have a net positive power aligned along the optical path proximate to the intermediate image. The field lens group can include a plurality of lens elements with different dispersions. The lens surfaces can be disposed at second predetermined positions and having curvatures selected to provide substantial correction of chromatic aberrations including at least secondary longitudinal color as well as primary and secondary lateral color of the system over the wavelength band.

The catadioptric lens group can include at least two reflective surfaces and at least one refractive surface disposed to form a real image of the intermediate image, such that, in combination with the focusing lens group, primary longitudinal color of the system is substantially corrected over the wavelength band. The zooming tube lens group, which can zoom or change magnification without changing its higher-order chromatic aberrations, can include lens surfaces disposed along one optical path of the system. The folding mirror group can be configured to allow linear zoom motion, thereby providing both fine zoom and wide range zoom.

A catadioptric imaging system is also described. This system can include an ultraviolet (UV) light source for generating UV light. This UV light source can include a fundamental laser for generating a fundamental frequency of approximately 1064 nm, an OP module for down converting the fundamental frequency or a harmonic frequency to generate an OP output, and a plurality of harmonic generators and frequency mixing modules for generating a plurality of frequencies, wherein the fundamental frequency, the plurality of frequencies, and the signal frequency are used to generate approximately 193.368 nm wavelength light. The UV light source is optimized to use at least one unconsumed frequency. Adaptation optics are also provided to control the illumination beam size and profile on the surface being inspected. An objective can include a catadioptric objective, a focusing lens group, and a zooming tube lens section in operative relation to each other. A prism can be provided for directing the UV light along the optical axis at normal incidence to a surface of a sample and directing specular reflections from surface features of the sample as well as reflections from optical surfaces of the objective along an optical path to an imaging plane.

A surface inspection apparatus is also described. This apparatus can include a laser system for generating a beam of radiation at approximately 193.368 nm. The laser system can include a fundamental laser for generating a fundamental frequency of approximately 1063 nm, an OP module for down converting the fundamental frequency or a harmonic frequency to generate an OP output, and a plurality of harmonic generators and frequency mixing modules for generating a plurality of frequencies, wherein the fundamental frequency, the plurality of frequencies, and the signal frequency are used to generate the 193.368 nm radiation. The laser system is optimized to use at least one unconsumed frequency. An illumination system can be configured to focus the beam of radiation at a non-normal incidence angle relative to a surface to form an illumination line on the surface substantially in a plane of incidence of the focused beam. The plane of incidence is defined by the focused beam and a direction that is through the focused beam and normal to the surface.

An optical system for detecting anomalies of a sample is also described. This optical system includes a laser system for generating first and second beams. The laser system includes a laser system for generating an output beam of radiation at approximately 193.368 nm. This laser system can include a fundamental laser for generating a fundamental frequency of approximately 1064 nm, an OP module for down converting the fundamental frequency or a harmonic frequency to generate an OP output, and a plurality of harmonic generators and frequency mixing modules for generating a plurality of frequencies, wherein the fundamental frequency, the plurality of frequencies, and the OP output are used to generate the 193.368 nm radiation. The laser system is optimized to use at least one unconsumed frequency. The output beam can be split into the first and second beams using standard components. First optics can direct the first beam along a first path onto a first spot on a surface of the sample. Second optics can direct the second beam along a second path onto a second spot on a surface of the sample. The first and second paths are at different angles of incidence to the surface of the sample. Collection optics can include a curved mirrored surface that receive scattered radiation from the first or the second spot on the sample surface and originate from the first or second beam and focus the scattered radiation to a first detector. The first detector provides a single output value in response to the radiation focused onto it by said curved mirrored surface. An instrument can be provided that causes relative motion between the first and second beams and the sample so that the spots are scanned across the surface of the sample.

### BRIEF DESCRIPTION OF THE DRAWINGS

FIG. 1A illustrates a block diagram of an exemplary laser for generating approximately 193.368 nm light using an optical parametric module and a fifth harmonic generator.

FIG. 1B illustrates a block diagram of another exemplary laser for generating approximately 193.368 nm light using an optical parametric module and a fifth harmonic generator.

FIG. 1C illustrates a block diagram of yet another exemplary laser for generating approximately 193.368 nm light using an optical parametric module and a fourth harmonic generator module.

FIG. 2A illustrates an exemplary fifth harmonic generator module.

FIG. 2B illustrates another exemplary fifth harmonic generator module.

FIG. 3A illustrates yet another exemplary fifth harmonic generator module.

FIG. 3B illustrates another exemplary fifth harmonic generator module.

FIG. 4 illustrates a block diagram of yet another exemplary laser for generating 193 nm light using an optical parametric module and a 4^{th} harmonic generator.

FIG. 5 illustrates a block diagram of an exemplary fundamental laser.

FIG. 6 illustrates an exemplary degenerate OP amplifier that creates infra-red light of twice the fundamental wavelength or half the fundamental frequency.

FIG. 7 illustrates another exemplary OP amplifier that creates infra-red light that is not exactly twice the fundamental wavelength or half the fundamental frequency.

FIG. 8 illustrates an exemplary inspection system including the improved laser.

FIG. 9 illustrates a reticle, photomask, or wafer inspection system that simultaneously detects two channels of image (or signal) on one sensor.

FIG. 10 illustrates an exemplary inspection system including multiple objectives and the improved laser.

FIG. 11 illustrates the optics of an exemplary inspection system with adjustable magnification including the improved laser.

FIG. 12 illustrates an exemplary inspection system with dark-field and bright-field modes and including the improved laser.

FIG. 13A illustrates a surface inspection apparatus including the improved laser. FIG. 13B illustrates an exemplary array of collection optics for the surface inspection apparatus.

FIG. 14 illustrates an exemplary surface inspection system including the improved laser.

FIG. 15 illustrates an inspection system including the improved laser and using both normal and oblique illumination beams.

### DETAILED DESCRIPTION OF THE DRAWINGS

In accordance with an improved laser technique and laser system described herein, an ultra-violet (UV) wavelength of approximately 193.4 nm (for example a vacuum wavelength near 193.368 nm) can be generated from a fundamental vacuum wavelength near 1063.5 nm (for example near 1063.52 nm, or, in another example between about 1064.0 nm and about 1064.6 nm). Where a wavelength is given without qualification herein, it is to be assumed that it refers to the vacuum wavelength of the light.

Every embodiment of the present invention uses at least one frequency in more than one frequency conversion stage. In general, frequency conversion stages do not completely consume their input light, which can be advantageously leveraged in the improved laser systems described herein. Preferred embodiments of the invention separate out an unconsumed portion of an input wavelength to at least one stage and redirect that unconsumed portion for use in another stage. Frequency conversion and frequency mixing are non-linear processes. The conversion efficiency increases with increased input power level. For example, the entire output of the fundamental laser may be directed first to one stage, such as a second harmonic generator, in order to maximize the efficiency of that stage and minimize the length (and hence cost) of the crystal used for that stage. In this example, the unconsumed portion of the fundamental would be directed to another stage, such as a fifth harmonic generator or an optical parametric module, for use in that stage.

An advantage of separating out an unconsumed input frequency and directing it separately to another stage rather than allowing it to co-propagate with the output of that stage is that the optical path lengths can be separately controlled for each frequency, thereby ensuring that the pulses arrive simultaneously. Another advantage is that coatings and optical components can be optimized for each individual frequency rather than being compromised between the needs of two frequencies. In particular, the output frequency of a second harmonic or fourth harmonic generator will have a perpendicular polarization relative to the input frequency. A Brewster window for admitting one frequency with minimal reflection will generally have a high reflectivity for the other frequency because its polarization will wrong for that window.

Preferred embodiments of the present invention use protective environments for the frequency conversion and frequency mixing stages that generate deep UV wavelengths (such as wavelengths shorter than about 350 nm). Suitable protective environments are described in U.S. Pat. No. 8,298,335, entitled “Enclosure for controlling the environment of optical crystals”, issued to Armstrong on Oct. 30, 2012 and U.S. Published Application 2013/0021602, entitled “Laser With High Quality, Stable Output Beam, And Long Life High Conversion Efficiency Non-Linear Crystal” by Dribinski et al., published on Jan. 24, 2013, both of which are incorporated by reference herein. In particular, Brewster windows are useful in such environments for allowing the input and output frequencies to enter or leave. Directing each frequency separately allows use of separate Brewster windows or coatings where necessary to minimize losses and stray light within the laser system.

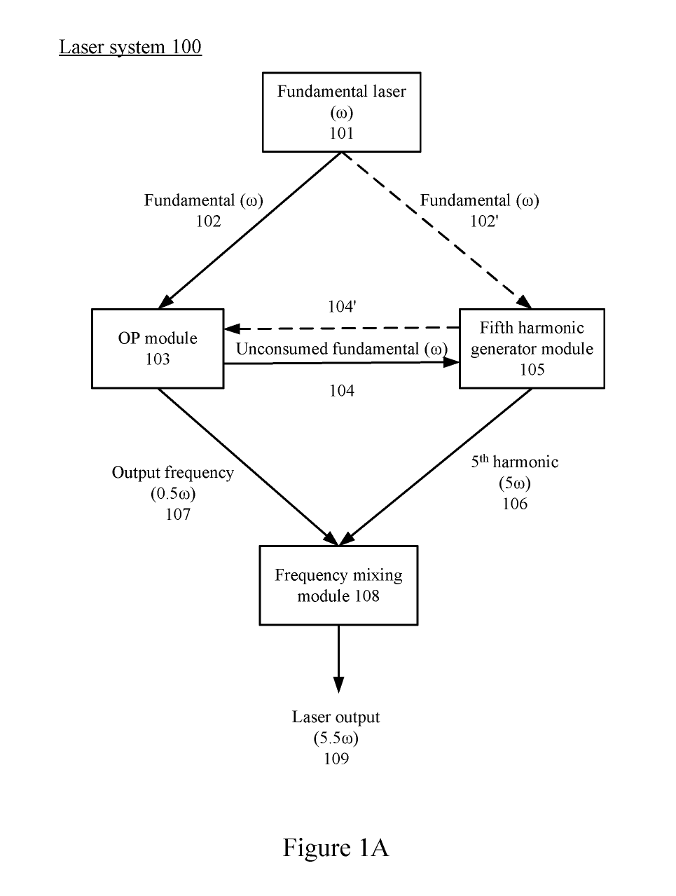

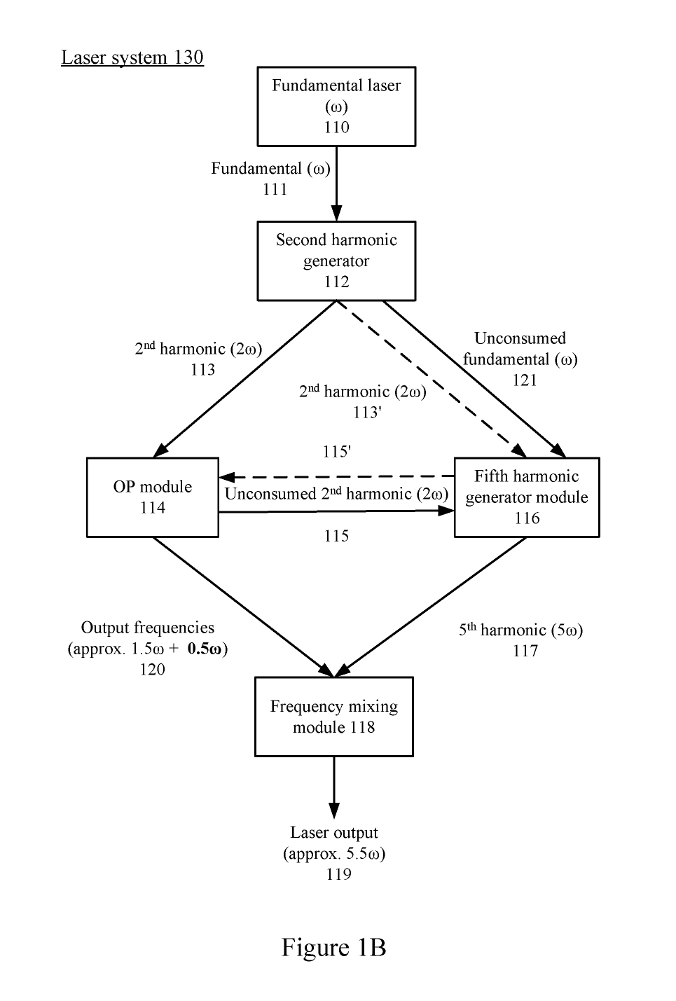

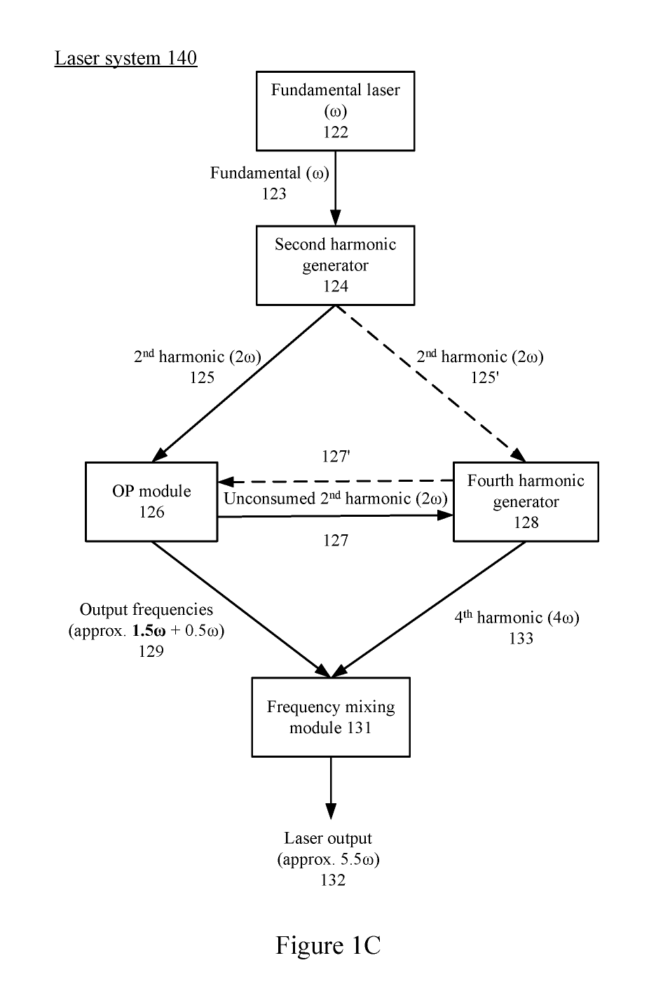

The improved laser techniques and laser systems described below use half harmonics to divide the fundamental wavelength by 5.5 (i.e. multiplying the fundamental frequency by 5.5). Note that dividing a wavelength by N can also be described as multiplying its corresponding frequency by N, wherein N is any number whether integer or fraction. As used in the drawings, ω is designated as the fundamental frequency. For example, FIGS. 1A-1C indicate the wavelengths of light (relative to the fundamental) generated by various components of exemplary laser systems in parentheticals, e.g. (ω), (0.5ω), (1.5ω), (2ω), (4ω), (4.5ω), and (5ω). Note that a harmonic of the fundamental frequency can be indicated using similar designations, e.g. the fifth (5^{th}) harmonic is equivalent to 5ω. The harmonics of 0.5ω, 1.5ω, and 4.5ω can also be called half harmonics. Note that in some embodiments, frequencies slightly shifted from 0.5ω are used rather than exactly 0.5ω. Frequencies described as approximately 0.5ω, approximately 1.5ω etc. may refer to exact half harmonics or slightly shifted frequencies depending on the embodiment. For ease of reference in describing elements of the drawings, the numerical designation (e.g. “5^{th} harmonic”) refers to the frequency itself, whereas the word designation (e.g. “fifth harmonic”) refers to the component generating the frequency.

FIG. 1A illustrates an exemplary laser system 100 for generating a ultra-violet (UV) wavelength of approximately 193.4 nm. In this embodiment, laser system 100 includes a fundamental laser 101 that generates light at a fundamental frequency ω, i.e. fundamental 102. In one embodiment, the fundamental frequency ω can be the frequency corresponding to an infra-red wavelength near 1064 nm. For example, in some preferred embodiments, fundamental laser 101 can emit a wavelength of substantially 1063.52 nm. In other embodiments, fundamental laser 101 can emit a wavelength between about 1064.0 nm and about 1064.6 nm. Fundamental laser 101 can be implemented by a laser using a suitable lasing medium, such as Nd:YAG (neodymium-doped yttrium aluminum garnate) or Nd-doped yttrium orthovanadate. A neodymium doped mixture of gadolinium vanadate and yttrium vanadate (for example, an approximately 50:50 mixture of the two vanadates) is another suitable lasing medium that can have higher gain near 1063.5 nm in wavelength than either Nd:YAG or neodymium-doped yttrium orthovandate. Ytterbium-doped fiber lasers are another alternative that can be used to generate laser light at a wavelength near 1063.5 nm. Lasers that could be modified or tuned to work at approximately 1063.5 nm in wavelength are commercially available as pulsed lasers (Q-switched or mode-locked) or CW (continuous wave) lasers. Exemplary manufacturers of such modifiable lasers include Coherent Inc. (e.g. models in the Paladin family with repetition rates of 80 MHz and 120 MHz), Newport Corporation (e.g. models in the Explorer family), and other manufacturers. Techniques that can be used with fundamental laser 101 to control the wavelength and bandwidth include distributed feedback, or the use of wavelength selective devices such as fiber Bragg gratings, diffraction gratings or etalons. In other embodiments, a commercially available laser, such as those just listed, is operated at its standard wavelength, which is typically a wavelength between about 1064.0 nm and about 1064.6 nm. In such embodiments, the signal or idler frequency (see below) may be shifted from exactly 0.5ω so as to generate the desired output wavelength.

Notably, fundamental laser 101 determines the overall stability and bandwidth of the output light. Stable, narrow-bandwidth lasers are generally easier to achieve at low and moderate power levels, such as levels of about 1 mW to a few tens of Watts. Stabilizing the wavelength and narrowing the bandwidth of higher power or shorter wavelength lasers is more complex and expensive. Laser power levels for fundamental laser 101 can range from milliWatts to tens of Watts or more. Therefore, fundamental laser 101 can be easily stabilized.

Fundamental 102 can be directed towards an optical parametric oscillator (OPO) or an optical parametric amplifier (OPA). An OPO, which oscillates at optical frequency, down converts its input frequency into one or two output frequencies by means of a second order non-linear optical interaction. In the case of two output frequencies, a “signal” frequency and an “idler” frequency are generated (shown in the drawings as “(signal+idler)”). The sum of the two output frequencies is equal to the input frequency. In the case of one output frequency, called a degenerate OP module, the signal and idler frequencies are the same and therefore are for all practical purposes indistinguishable. An OPA is a laser light source that amplifies seed (or input) light of input wavelength using an optical parametric amplification process. For simplicity, the generic term “OP module” is used herein to refer to either an OPO or an OPA.

In laser system 100, an OP module 103 down converts a portion of fundamental 102 into a degenerate output frequency (approximately 0.5ω) 107. Thus, in the degenerate case, the wavelength of the down converted light output by OP module 103 is twice the wavelength of fundamental 102. For example, if fundamental 102 has a wavelength of 1063.5 nm, the wavelength of signal 107 is 2127 nm. In some embodiments, OP module 103 can include a non-linear crystal such as periodically polled lithium niobate, magnesium-oxide-doped lithium niobate, or KTP (potassium titanyl phosphate). In some embodiments, OP module 103 can include a low-power laser, such as a diode laser or a low-powered fiber laser.

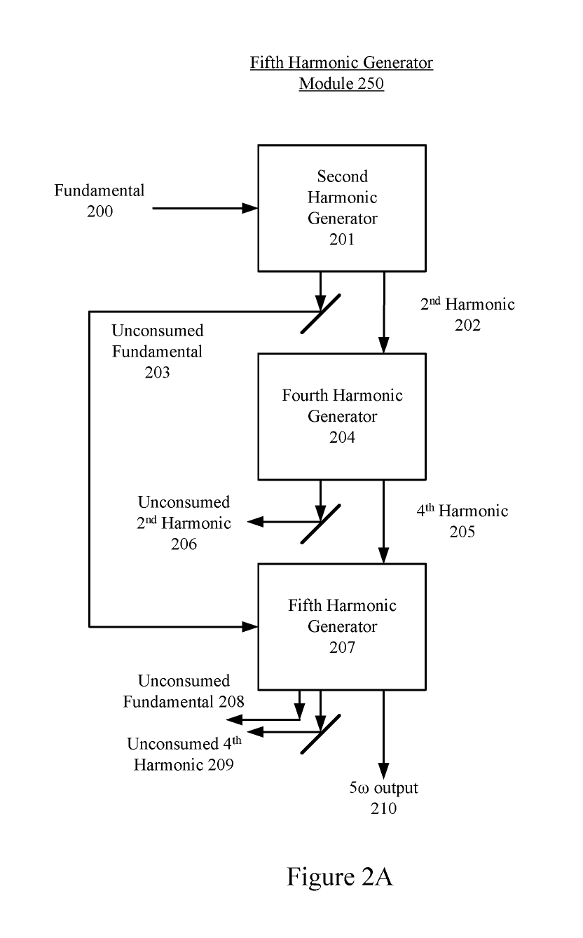

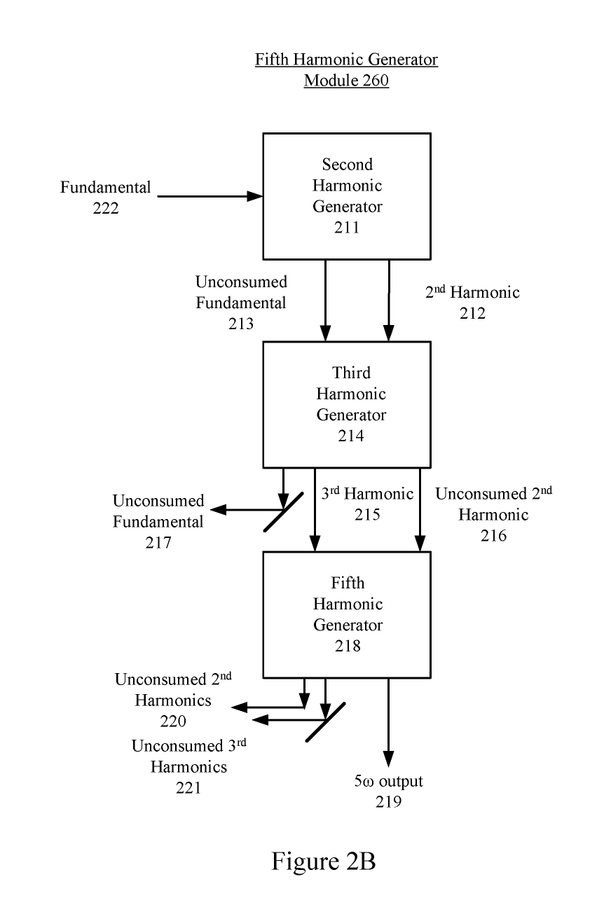

Notably, only part of fundamental 102 is consumed in the down conversion process. Indeed, in general, OP modules and harmonic generators do not completely consume their input light, which can be advantageously leveraged in the improved laser systems described herein. For example, an unconsumed fundamental 104 of OP module 103 can be directed to a fifth-harmonic (5ω) generator module 105, which comprises several frequency conversion and mixing stages to generate the 5^{th} harmonic from the fundamental (described in detail below in reference to FIGS. 2A and 2B).

Similarly, in an alternative embodiment, the fundamental 102′ can be directed first to the fifth-harmonic generator module 105 to generate a 5^{th} harmonic 106, and the fundamental 102′ not consumed in the generation of the 5^{th} harmonic 106 (unconsumed fundamental 104′) can be directed to OP module 103 for down conversion to the output frequency 107.

The output of fifth-harmonic generator module 105, i.e. 5^{th} harmonic 106, can be combined (i.e. mixed) with output frequency 107 in a frequency mixing module 108. In one embodiment, frequency mixing module 108 can include one or more non-linear crystals (of the same type), such as beta barium borate (BBO), lithium triborate (LBO), or hydrogen-annealed cesium lithium borate (CLBO) crystals. Frequency mixing module 108 generates a laser output 109 having a frequency at approximately 5.5ω with a corresponding wavelength of 193.368 nm (i.e. the fundamental wavelength divided by approximately 5.5).

The advantage of using type I degenerate down conversion is that no power is wasted in generating an unwanted wavelength or polarization. If a fundamental laser of sufficient power at a wavelength 5.5 times the desired output wavelength near 193.368 nm is readily available at a reasonable cost, embodiments including degenerate down conversion may be preferred. The advantage of non-degenerate down conversion is that lasers at wavelengths between about 1064.0 nm and about 1064.6 nm are readily available with power levels of tens of Watts or 100 W, whereas lasers at wavelengths of substantially 1063.5 nm are not currently readily available at such power levels. Non-degenerate down conversion allows readily available high-power lasers to generate any desired output wavelength close to 193.368 nm.

FIG. 1B illustrates another exemplary laser system 130 for generating a UV wavelength of approximately 193.368 nm. In this embodiment, a fundamental laser 110 operating at a fundamental frequency ω generates fundamental 111. In one embodiment, frequency ω may correspond to a wavelength of approximately 1063.5 nm or, in another embodiment, to a wavelength between about 1064.0 nm and about 1064.6 nm. Fundamental 111 can be directed to a second harmonic generator module 112, which doubles fundamental 111 to generate a 2^{nd} harmonic 113. An unconsumed portion of the fundamental 111 from second harmonic generator module 112, i.e. unconsumed fundamental 121, can be directed to a fifth-harmonic generator module 116. The 2^{nd} harmonic 113 can be directed to an OP module 114. In some embodiments, OP module 114 can include a non-linear crystal such as periodically polled lithium niobate, magnesium-oxide-doped lithium niobate, or KTP. In some embodiments, OP module 114 can include a low-power laser, such as a diode laser or a low-powered fiber laser.

In one preferred embodiment, OP module 114 generates output frequencies 120 including a signal at approximately 1.5ω and an idler at approximately 0.5ω. Note that because the wavelengths of the signal and the idler are quite different in this embodiment, the signal and the idler can be readily separated using, for example, dichroic coatings, prisms, or gratings. In some embodiments, the signal and the idler have substantially orthogonal polarizations and therefore can be separated by, for example, a polarizing beam splitter. In laser system 130, the idler at 0.5ω or approximately 0.5ω is the frequency component of interest. For example, if the fundamental 102 is at a wavelength of 1063.5 nm, the wavelength of the down converted light output by OP module 114 associated with the idler is 2127 nm, which is twice the wavelength of fundamental 102. In another example, if fundamental 102 is at a wavelength of 1064.4 nm and the desired output wavelength is 193.368 nm, then the idler wavelength will be 2109.7 nm.

Note that in other embodiments, it is not necessary to separate the signal and the idler because only the desired wavelength properly phase matches in the frequency mixing module 118. That is, frequency mixing module 118 can be configured to receive both the signal and the idler, but only actually use the idler, which is at 0.5ω. Because the unwanted wavelength in these embodiments is a wavelength of approximately 710 nm, most non-linear crystals suitable for use in frequency mixing module 118 do not significantly absorb at such wavelengths, and so the unwanted wavelength is unlikely to cause significant heating or other undesired effects.

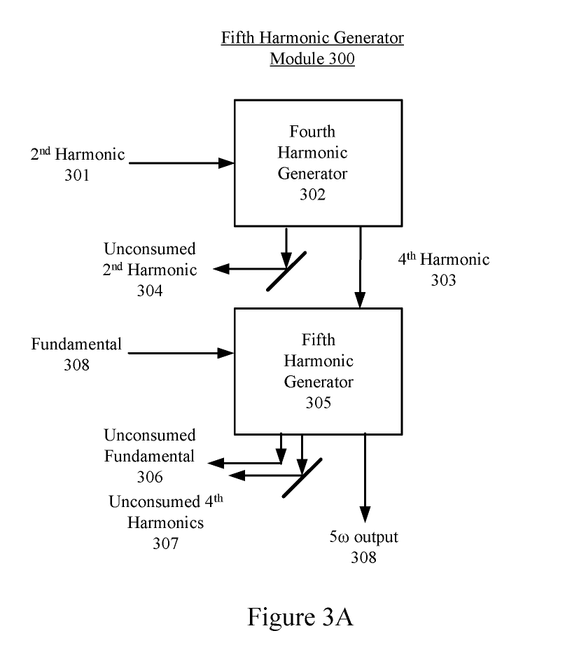

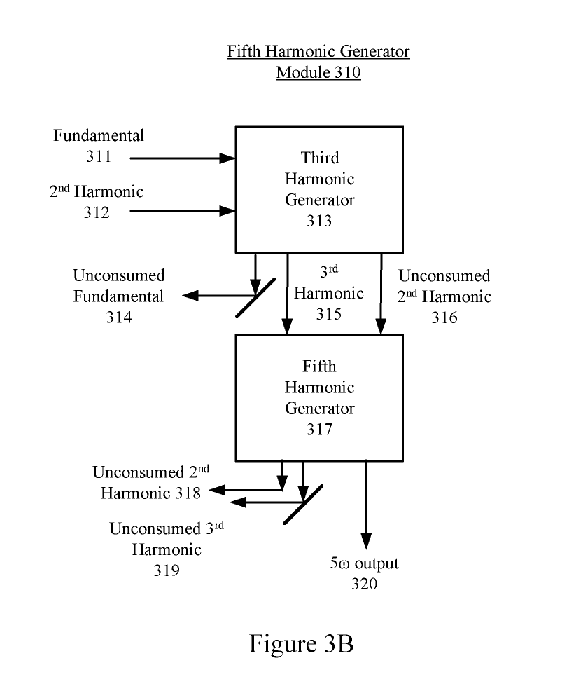

Fifth harmonic generator module 116 combines an unconsumed 2^{nd} harmonic 115 from OP module 114 and unconsumed fundamental 121 to generate a 5^{th} harmonic 117 (see, e.g. FIGS. 3A and 3B for exemplary fifth harmonic generator modules). A frequency mixing module 118 mixes 5^{th} harmonic 117 and the idler portion of output frequencies 120 to create a laser output 119 at approximately 5.5ω. In one embodiment, frequency mixing module 118 can include one or more non-linear crystals, such as BBO (beta barium borate), LBO, or CLBO crystals.

Note that, in a manner analogous to that illustrated in FIG. 1A for the fundamental 102 and 102′, in some embodiments of laser system 130, the 2^{nd} harmonic 113′ may be directed first to the fifth harmonic generator module 116, and the unconsumed portion of that 2^{nd} harmonic 115′ directed to OP module 114 as shown by the dashed lines.

FIG. 1C illustrates yet another exemplary laser system 140 for generating a UV wavelength of approximately 193.4 nm. In this embodiment, a fundamental laser 122 operating at a frequency ω generates a fundamental 123. In this embodiment, frequency ω may correspond to a wavelength of approximately 1063.5 nm or a wavelength between about 1064.0 nm and about 1064.6 nm.

Fundamental 123 can be directed to a second harmonic generator module 124, which doubles fundamental 123 to generate a 2^{nd} harmonic 125. The 2^{nd} harmonic 125 is directed to an OP module 126. In one embodiment, OP module 126 generates output frequencies 129 including a signal 129 at approximately 1.5ω and an idler at approximately 0.5ω. In some embodiments, OP module 126 can include a non-linear crystal such as periodically polled lithium niobate, magnesium-oxide-doped lithium niobate, or KTP. In other embodiments, OP module 126 can include a low-power laser, such as a diode laser or a low-powered fiber laser. As discussed below, the signal portion of output frequencies 129 (at approximately 1.5ω) is the frequency component of interest to frequency mixing module 131.

An unconsumed 2^{nd} harmonic 127 of OP module 126 can be directed to a fourth harmonic generator module 128. Fourth harmonic generator module 128 doubles unconsumed 2^{nd} harmonic 127 to generate a 4^{th} harmonic 133.

In some embodiments, the 2^{nd} harmonic 125′ from the second harmonic generator 124 is directed first to the fourth harmonic generator 128, and the unconsumed 2^{nd} harmonic 127′ from the fourth harmonic generator 128 is directed to the OP module 126 for down conversion.

In laser system 140, frequency mixing module 131 combines the signal portion of output frequencies 129 and 4^{th} harmonic 133 to generate a laser output 132 having a wavelength of approximately 5.5ω. As noted above, because of the difference in frequency of the signal and the idler, the idler may not need separating from the signal before being received by frequency mixing module 131. In one embodiment, frequency mixing module 131 can include a non-critically phase-matched BBO or KBBF (potassium fluoroboratoberyllate) crystal operating at a temperature of approximately 120° C. to combine the 4^{th} harmonic 133 with the 1.5ω signal to achieve the 5.5ω output 132.

FIG. 2A illustrates an exemplary fifth harmonic generator module 250. In this embodiment, a second harmonic generator 201 receives a fundamental 200 (ω) (or an unconsumed fundamental) from a stage external to the fifth harmonic generator module 250 and doubles it to generate a 2^{nd} harmonic 202. A fourth harmonic generator 204 receives 2^{nd} harmonic 202 and doubles it to generate a 4^{th} harmonic 205. A fifth harmonic generator 207 combines 4^{th} harmonic 205 and an unconsumed fundamental 203 from second harmonic generator 201 to generate a 5^{th} harmonic output 210. Note that an unconsumed 2^{nd} harmonic 206 of second harmonic generator 201, an unconsumed fundamental 208 of fifth harmonic generator 207, and an unconsumed 4^{th} harmonic 209 of fifth harmonic generator 207 are not used in this embodiment, and therefore may be separated from the output, if desired. In one embodiment, unconsumed fundamental 208 can be redirected to the OP module 103 of FIG. 1A as shown by dashed line 104′ in that figure.

FIG. 2B illustrates another exemplary fifth harmonic generator module 260. In this embodiment, a second harmonic generator 211 receives a fundamental 222 (ω) (or an unconsumed fundamental) from a stage external to the fifth harmonic generator module and doubles it to generate a 2^{nd} harmonic 212. A third harmonic generator 214 combines 2^{nd} harmonic 212 as well an unconsumed fundamental 213 of second harmonic generator 211 to generate a 3^{rd} harmonic 215. A fifth harmonic generator 218 combines 3^{rd} harmonic 215 and an unconsumed 2^{nd} harmonic 216 of third harmonic generator 214 to generate a 5^{th} harmonic output 219. Note that an unconsumed fundamental 217 of third harmonic generator 214, an unconsumed 2^{nd} harmonic 220 of fifth harmonic generator 218, and an unconsumed 3^{rd} harmonic 221 of fifth harmonic generator 218 are not used in this embodiment and therefore may be separated from the output, if desired. Note that in one embodiment, unconsumed fundamental 217 may be directed to the OP module 103 of FIG. 1A as shown by dashed line 104′ in that figure.

FIG. 3A illustrates yet another exemplary fifth harmonic generator module 300. In this embodiment, a fourth harmonic generator 302 receives a 2^{nd} harmonic 301 from a stage external to the fifth harmonic generator module 300 and doubles it to generate a 4^{th} harmonic 303. A fifth harmonic generator 305 combines 4^{th} harmonic 303 as well a fundamental 308 (or an unconsumed fundamental) from a stage external to the fifth harmonic generator module 300 to generate a 5^{th} harmonic output 308. Note that an unconsumed 2^{nd} harmonic 304 of 4^{th} harmonic generator 302, an unconsumed fundamental 306 of fifth harmonic generator 305, and an unconsumed 4^{th} harmonic 307 of fifth harmonic generator 305 are not used in this embodiment and therefore may be separated from the outputs, if desired. Note that in one embodiment the unconsumed 2^{nd} harmonic 304 may be directed to the OP module 114 of FIG. 1B as shown by dashed line 115′ in that figure.

FIG. 3B illustrates yet another exemplary fifth harmonic generator module 310. In this embodiment, a third harmonic generator 313 combines a fundamental 311 (or an unconsumed fundamental) from a stage external to the fifth harmonic generator module 310 and a 2^{nd} harmonic 312 (or an unconsumed 2^{nd} harmonic) also from a stage external to the fifth harmonic generator module 310 to generate a 3^{rd} harmonic 315. A fifth harmonic generator 317 combines 3^{rd} harmonic 315 and an unconsumed 2^{nd} harmonic from 3^{rd} harmonic generator 313 to generate a 5^{th} harmonic output 320. Note that an unconsumed fundamental 314 of 3^{rd} harmonic generator 313, an unconsumed 2^{nd} harmonic 318 of 5^{th} harmonic generator 317, and an unconsumed 3^{rd} harmonic 319 of fifth harmonic generator 317 are not used in this embodiment and therefore may be separated from the outputs, if desired. Note that in one embodiment the unconsumed 2^{nd} harmonic 318 may be directed to the OP module 114 of FIG. 1B as shown by dashed line 115′ in that figure.

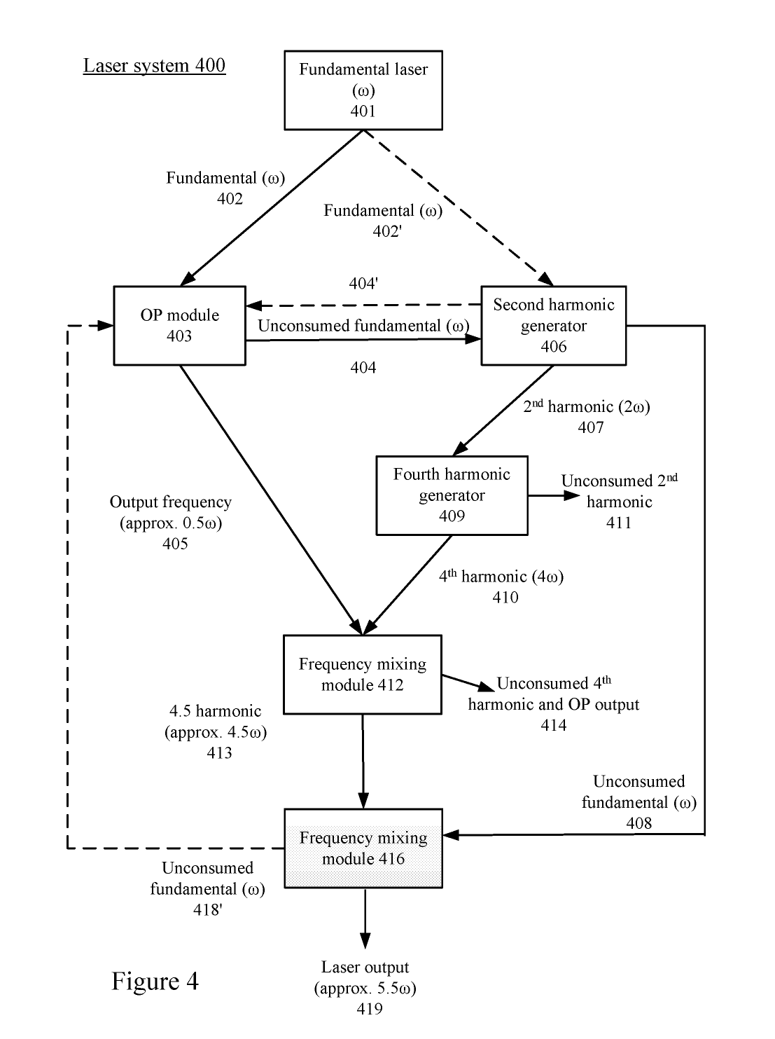

FIG. 4 illustrates another exemplary laser system 400 for generating a UV wavelength of approximately 193.4 nm. In this embodiment, a fundamental laser 401 operating at a frequency ω generates a fundamental 402. An OP module 403 uses fundamental 402 to generate a degenerate or non-degenerate output frequency 405. Thus, for example, if the fundamental 402 is at a wavelength of 1063.5 nm, the wavelength of the down converted light of the output frequency is 2127 nm, which is twice the wavelength of fundamental 402. In another example, if fundamental 402 is at a wavelength of 1064.4 nm and the desired output wavelength is 193.368 nm, then the output frequency 405 will correspond to the signal wavelength of 2109.7 nm. In some embodiments, OP module 403 can include a non-linear crystal such as periodically polled lithium niobate, magnesium-oxide-doped lithium niobate, or KTP. In some embodiments, OP module 403 can include a low-power laser, such as a diode laser or a low-powered fiber laser.

A second harmonic generator 406 doubles an unconsumed fundamental 404 from OP module 403 to generate a 2^{nd} harmonic 407. A fourth harmonic generator 409 doubles 2^{nd} harmonic 407 to generate a 4^{th} harmonic 410. A frequency mixing module 412 combines the output frequency 405 and the 4^{th} harmonic 410 to generate an approximately 4.5 harmonic 413, which has a wavelength of approximately 236 nm. A frequency mixing module 416 mixes the approximately 4.5 harmonic 413 and an unconsumed fundamental 408 from second harmonic generator 406 to generate an approximately 5.5ω laser output 417 having a wavelength of approximately 193.368 nm.

Note that an unconsumed 2^{nd} harmonic 411 of fourth harmonic generator 409, an unconsumed 4^{th} harmonic and unconsumed OP signal 414 from frequency mixing module 412 are not used in this embodiment and therefore may be separated from the outputs, if desired.

Note further that the fundamental (ω) is used in three modules: second harmonic generator 406, the frequency mixing module 416, and the OP module 403. Various different schemes for leveraging the unconsumed fundamental from a generator or module are possible. For example, in some embodiments, the fundamental, instead of being provided directly to OP module 403 by fundamental laser 401 as shown by fundamental 402, may include an unconsumed fundamental 404′ from second harmonic generator 406. Likewise, in certain preferred embodiments, fundamental (ω) 402′ may be provided directly to second harmonic generator 406 in order to more easily generate more second harmonic 407. Unconsumed fundamental 408 and/or 404′ from the output of second harmonic generator 406 may be directed to frequency mixing module 416 and/or OP module 403, respectively. In some embodiments, an unconsumed fundamental 418′ from frequency mixing module 416 may be directed to OP module 403.

It is to be understood that the drawings of the various laser systems are intended to illustrate exemplary components/steps to generate a predetermined frequency output light from a predetermined frequency input light. For simplicity, the drawings show the main optical modules and harmonic generators involved in this process. Thus, the drawings are not meant to represent the actual physical layout of the components and actual implementations would typically include additional optical elements.

For example, in any of the embodiments described herein, mirrors may be used to direct the fundamental or other harmonics as needed. Other optical components, such as prisms, beam splitters, beam combiners, and dichroic coated mirrors, for example, may be used to separate and combine beams as necessary. Various combinations of mirrors and beam splitters may be used to separate and route the various wavelengths between different harmonic generators and mixers in any appropriate sequence. Lenses and/or curved mirrors may be used to focus the beam waist to foci of substantially circular or elliptical cross sections inside or proximate to the non-linear crystals where appropriate. Prisms, gratings or diffractive optical elements may be used to separate the different wavelengths at the outputs of the harmonic generators and the mixer module when needed. Prisms, coated mirrors, or other elements may be used to combine the different wavelengths at the inputs to the harmonic generators and mixers as appropriate. Beam splitters or coated mirrors may be used as appropriate to separate wavelengths or to divide one wavelength into two beams. Filters may be used to block undesired and/or unconsumed wavelengths at the output of any stage. Waveplates may be used to rotate the polarization as needed, for example, in order to correctly align the polarization of an input wavelength relative to the axes of a non-linear crystal. One skilled in the appropriate arts would understand how to build lasers according to the embodiments from the drawings and their associated description.

Although the unconsumed fundamental and the unconsumed harmonics are shown in the embodiments as being separated from the desired harmonic when not needed for a subsequent harmonic generator, in some cases, it may be acceptable to allow unconsumed light to pass to a subsequent harmonic generator even though that light is not needed in that harmonic generator. This transfer of unconsumed light may be acceptable if the power density is low enough not to cause damage to the components of that stage and if there is minimal interference with the desired frequency conversion process (e.g. because of no phase matching at the crystal angle in use). One skilled in the appropriate arts would understand the various tradeoffs and alternatives to determine whether the unconsumed fundamental/harmonic should be separated from the desired harmonic.

In one embodiment, at least one of the second harmonic generators described above can include an LBO crystal, which is substantially non-critically phase-matched at temperature of about 149° C. to produce light at approximately 532 nm. In one embodiment, at least one of the third harmonic generators described above can include CLBO, BBO, LBO, or other non-linear crystals. In one embodiment, at least one of the fourth and fifth harmonic generators described above can use critical phase matching in CLBO, BBO, LBO, or other non-linear crystals. In some embodiments, the frequency mixing module such as 108 in FIG. 1A and 118 in FIG. 1B that mix 5ω with approximately 0.5ω, can include a CLBO or a LBO crystal, which is critically phase matched with a high D_{eff} (˜1 pm/V) and a low walk-off angle (<45 mrad for CLBO and <10 mrad for LBO). In other embodiments, the frequency mixing module such as 131 in FIG. 1C that mixes 4ω with approximately 1.5ω or 416 in FIG. 4 that mixes approximately 4.5ω with the fundamental can include a BBO or KBBF crystal.

In some embodiments, the fourth harmonic generator, the fifth harmonic generator, and/or the frequency mixing module can advantageously use some, or all, of the methods and systems disclosed in U.S. patent application Ser. No. 13/412,564, entitled “Laser with high quality, stable output beam, and long-life high-conversion-efficiency non-linear crystal”, filed on Mar. 5, 2012, as well as US Provisional Application number 61/510,633, entitled “Mode-locked UV laser with high quality, stable output beam, long-life high conversion efficiency non-linear crystal and a wafer inspection system using a mode-locked laser”, filed on Jul. 22, 2011, (and from which U.S. patent application Ser. No. 13/412,564 claims priority), both of which are incorporated by reference herein.

In one embodiment, any of the harmonic generators discussed herein may advantageously include hydrogen-annealed non-linear crystals. Such crystals may be processed as described in U.S. patent application Ser. No. 13/488,635 entitled “Hydrogen Passivation of Nonlinear Optical Crystals”, by Chuang et al., filed Jun. 1, 2012 and U.S. Provisional Application 61/544,425 entitled “Improvement of NLO Crystal Properties by Hydrogen Passivation”, by Chuang et al., filed on Oct. 7, 2011. Both of these applications are incorporated by reference herein. The hydrogen-annealed crystals may be particularly useful in those stages involving deep UV wavelengths, e.g. the fourth and fifth harmonic generators and the frequency mixing modules.

Note that in some embodiments, the frequency mixing module that mixes the signal frequency or idler frequency of the OP module with the fourth harmonic or fifth harmonic is placed inside the OP module. This avoids the need to bring the signal frequency or idler frequency out of the OP module. It also has the advantage of having the highest signal or idler (as appropriate) power level available for the frequency mixing making the mixing more efficient.

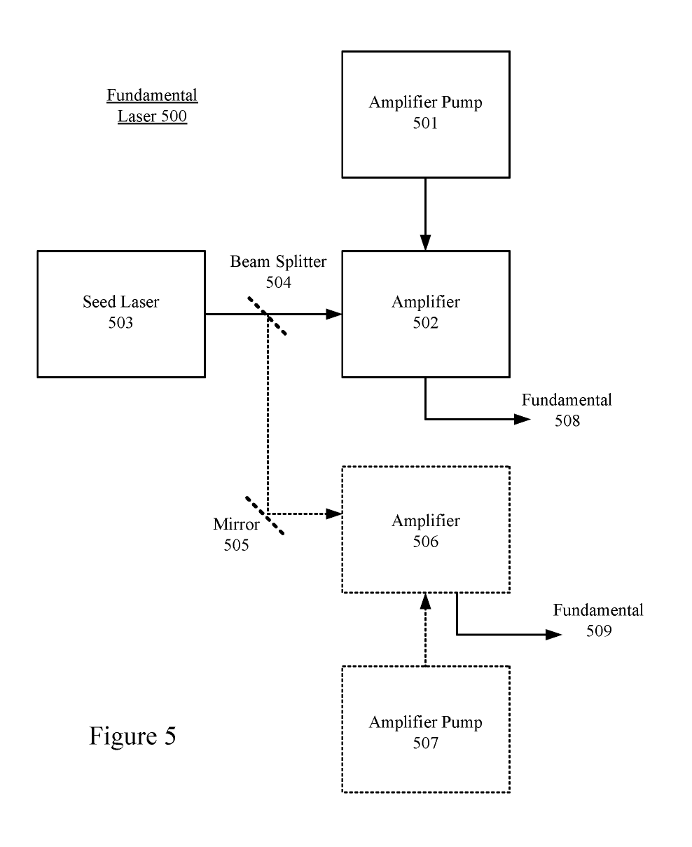

In one embodiment, to generate sufficient power at the fundamental (e.g. approximately 1063.5 nm wavelength), one or more amplifiers may be used to increase the power of the fundamental. If two or more amplifiers are used, then one seed laser can be used to seed those amplifiers, thereby ensuring that all amplifiers output the same wavelength and have synchronized output pulses. For example, FIG. 5 illustrates an exemplary configuration of a fundamental laser 500 including a seed laser (stabilized, narrow-band laser) 503 that generates seed light at the desired fundamental wavelength (e.g. approximately 1063.5 nm). Seed laser 503 could be implemented by, for example, a Nd doped YAG laser, a Nd-doped yttrium orthovanadate laser, a fiber laser, or a stabilized diode laser.

Amplifier 502 amplifies the seed light to a higher power level. In one embodiment, amplifier 502 can include Nd-doped YAG, Nd-doped yttrium orthovanadate, or an Nd-doped mixture of gadolinium vandate and yttrium orthovanadate. In other embodiments, amplifier 502 can include an Yb-doped fiber amplifier. An amplifier pump 501 can be used to pump amplifier 502. In one embodiment, amplifier pump 501 can include one or more diode lasers operating at approximately 808 nm in wavelength.

Because multiple frequency conversion stages may require the fundamental laser wavelength (depending on the output power required near 193.4 nm in wavelength), more fundamental laser light may be required than can conveniently be generated by a single amplifier. In such cases, multiple amplifiers may be used. For example, in fundamental laser 500, an amplifier 506 and an amplifier pump 507 can be provided in addition to amplifier 502 and amplifier pump 501. Like amplifier 502, amplifier 506 can also amplify the seed light to a higher power. Amplifier pump 507 can pump amplifier 506.

In a multiple amplifier embodiment, each amplifier can generate its own fundamental laser outputs. In FIG. 5, amplifier 502 can generate fundamental laser output (fundamental) 508 and amplifier 506 can generate fundamental laser output (fundamental) 509. In this configuration, fundamentals 508 and 509 can be directed to different frequency conversion stages. Note that to ensure that fundamentals 508 and 509 are at the same wavelength and are synchronized, seed laser 503 should provide the same seed light to amplifiers 502 and 506, amplifiers 502 and 506 should be substantially identical, and amplifier pumps 501 and 507 should be substantially identical. To ensure that the same seed light is provided to both amplifiers 502 and 506, a beam splitter 504 and a mirror 505 can divide the seed light and direct a fraction of it to amplifier 506. Although only two amplifiers are shown in FIG. 5, other embodiments of a fundamental laser may include more amplifiers, amplifier pumps, beam splitters, and mirrors in a similar configuration to generate multiple fundamental outputs.

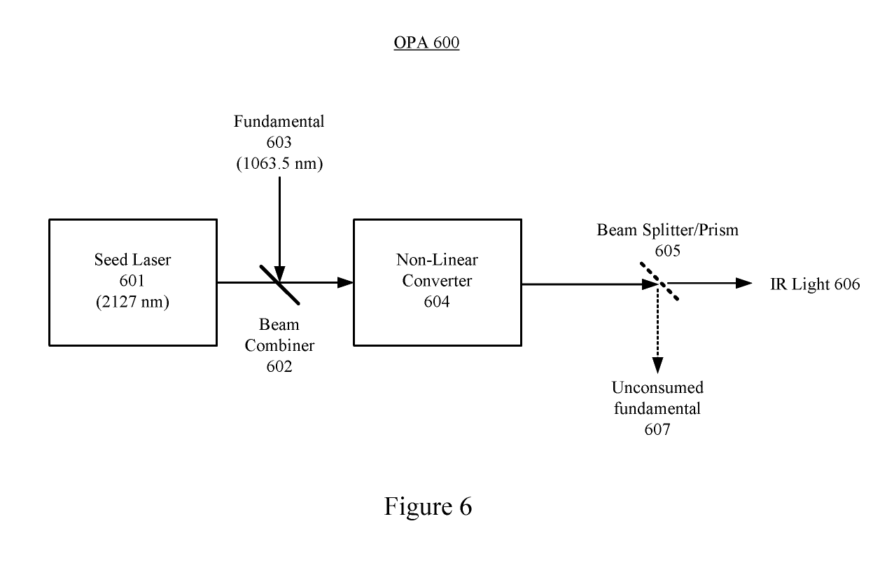

FIG. 6 illustrates an exemplary degenerate OPA 600 that creates infra-red light 606 of twice the fundamental wavelength (i.e. half the fundamental frequency). In this embodiment, a beam combiner 602 combines a fundamental 603 (e.g. 1063.5 nm) and seed light generated by a seed laser 601. In one embodiment, beam combiner 602 may include a dichroic coating that efficiently reflects one wavelength while transmitting the other wavelength. In another embodiment, beam combiner 602 may be a polarizing beam combiner that efficiently combines two substantially orthogonal polarizations. In the configuration shown in FIG. 6, the two wavelengths can travel substantially collinearly through a non-linear converter 604. Non-linear converter 604 may comprise periodically polled lithium niobate, magnesium oxide doped lithium niobate, KTP, or other suitable non-linear crystalline material.

In one embodiment, seed laser 601 can be a low-power laser (e.g. a diode laser or a low-powered fiber laser), which generates a seed wavelength of twice the wavelength of the fundamental laser (e.g. 2127 nm if the fundamental laser is 1063.5 nm). This wavelength can be used to seed the down conversion process in OPA 600. A laser diode may be based on a compound semiconductor such as GaInAs, InAsP, or GaInAsSb, with the appropriate composition to match the bandgap of the compound semiconductor to the approximately 0.5829 eV energy of a 2127 nm photon. In this diode configuration, seed laser 601 need only be of approximately 1 mW, a few mW or a few tens of mW in power. In one embodiment, seed laser 601 can be stabilized by using, for example, a grating and stabilizing the temperature. Seed laser 601 may generate polarized light, which is introduced into a non-linear crystal (of non-linear converter 604) and polarized substantially perpendicular to the polarization of the fundamental. In another embodiment, the non-linear crystal (of non-linear converter 604) may be contained in a resonant cavity to create a laser/amplifier based on spontaneous emission. In one embodiment, output wavelength 606 may be separated from an unconsumed fundamental 607 using a beam splitter or prism 605.

An advantage of using an OPA for degenerate down conversion is that seeding the OPA with a narrow-band stabilized seed laser signal will result in a narrow band output through stimulated emission. This overcomes the naturally tendency of degenerate down conversion to produce a broadband output (depending on the non-linear crystal) since the signal and idler can spontaneously be generated over any wavelength range that is phase matched in the non-linear crystal. In an OPO, it is generally difficult to fabricate filters with high reflectivity (or transmission, as appropriate) in the narrow band of wavelengths of interest (typically a bandwidth of a few tenths of a nm in the laser systems disclosed herein), but very low reflectivity (or transmission) outside that narrow band.

Other embodiments of an OPA may use a photonic crystal fiber to generate a wavelength of substantially twice the wavelength of the fundamental. Yet other embodiments of an OPA may use a seed laser diode operating at approximately 2127 nm to seed the photonic crystal fiber down converter (of non-linear converter 604). Using a non-linear optical crystal for the down conversion may be more efficient because the non-linear crystal (of non-linear converter 604) is a χ⁽²⁾ process instead of a χ⁽³⁾ process. Nonetheless, a photonic crystal may be useful in some circumstances.

Note that a laser may start with a wavelength that is not exactly equal to 5.5 times the output wavelength. For example, the fundamental may be at a wavelength of about 1064.4 nm, whereas the desired output wavelength is close to 193.368 nm. In that case, instead of using degenerate down conversion, two different output wavelengths (i.e. the signal and idler) can be generated by an OPO or OPA. Because these two wavelengths are close together (e.g. separated by a few nm or a few tens of nm in some embodiments), type II frequency conversion can be used (if phase matching can be achieved) so that the signal and idler have perpendicular polarizations and can be separated by a polarizing beam splitter. In other embodiments, an etalon of the appropriate length (or volume Bragg grating of the appropriate design) may be used to reflect or transmit the desired wavelength while not reflecting or transmitting (as appropriate) the other wavelength.

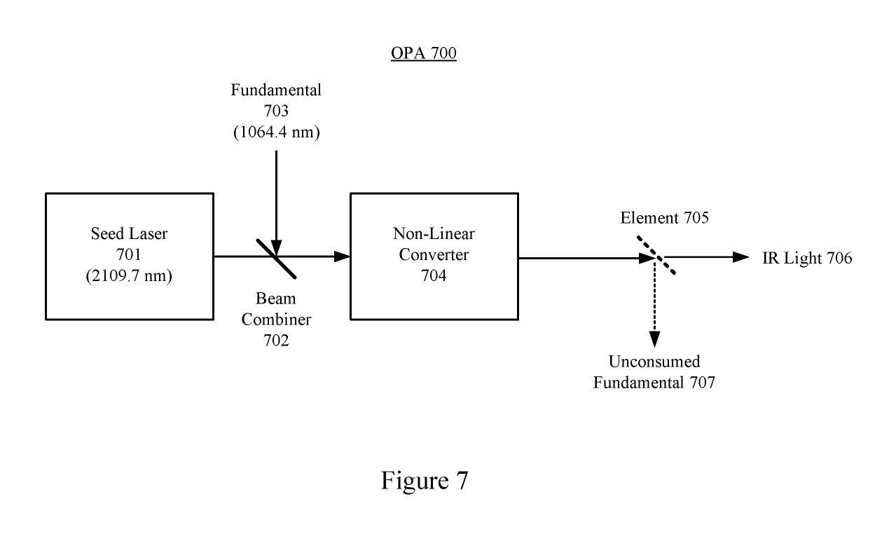

FIG. 7 illustrates an exemplary non-degenerate OPA 700 that creates infra-red light 706 of that is slightly shifted from twice the fundamental wavelength (i.e. half the fundamental frequency). In this embodiment, a beam combiner 702 combines a fundamental 703 (e.g. 1064.4 nm) and seed light generated by a seed laser 701 (at a wavelength of, e.g., 2109.7 nm if the fundamental is at 1064.4 nm and the desired laser system output wavelength is 193.368 nm). This fundamental wavelength can be generated by a Nd-doped YAG laser, a Nd-doped yttrium orthovanadate laser, a Nd-doped mixture of gadolinium vanadate and yttrium orthovanadate laser, or a Yb-doped fiber laser. In one embodiment, beam combiner 702 may include a dichroic coating or a diffractive optical element that efficiently reflects one wavelength while efficiently transmitting the other wavelength. In this configuration, the two wavelengths can travel substantially collinearly through a non-linear converter 704. Non-linear converter 704 may comprise periodically polled lithium niobate, magnesium oxide doped lithium niobate, KTP, or other suitable non-linear crystalline material. Non-linear converter 704 can amplify the seed wavelength and also generate a second wavelength (which, if the fundamental wavelength is 1064.4 nm and the seed wavelength is 2109.7 nm, will be approximately equal to 2148.2 nm).

An element 705, such as an output beam splitter, filter, etalon or diffractive optical element, can be used to separate an unwanted (e.g. approximately 2148.2 nm) wavelength 707 from the wanted (approximately 2109.7 nm) wavelength 706. Element 705 can also be used to separate any unconsumed fundamental from the output beam 706 if necessary. In some embodiments, an idler wavelength (such as 2148.2 nm) may be seeded rather than the signal wavelength. Note that when the idler is seeded, the signal bandwidth is determined by the bandwidths of both the fundamental laser and the seed laser, whereas when the signal is seeded, the bandwidth of the signal is largely determined by the seed laser bandwidth.

After separating these two wavelengths, the signal frequency (at, for example, a wavelength of 2109.7 nm) may be mixed with the fifth harmonic of the fundamental (which, for example, is at a wavelength of substantially 212.880 nm) to generate an output wavelength of substantially 193.368 nm. This mixing can be done following any of the embodiments described above or their equivalents. Alternatively, the substantially 2109.7 nm wavelength may be mixed with the fourth harmonic of the fundamental (which is at a wavelength of substantially 266.1 nm) to create light at substantially 236.296 nm. This, in turn, can be mixed with the fundamental (or an unconsumed fundamental) to create an output wavelength of substantially 193.368 nm. This mixing can be done following the embodiment shown in FIG. 4 or any of its equivalents.

A quasi-CW laser operating may be constructed using a high repetition rate laser, such as a mode-locked laser operating at approximately 50 MHz or higher repetition rate, for the fundamental laser. A true CW laser may be constructed using a CW laser for the fundamental laser. A CW laser may need one or more of the frequency conversion stages to be contained in resonant cavities to build up sufficient power density to get efficient frequency conversion.

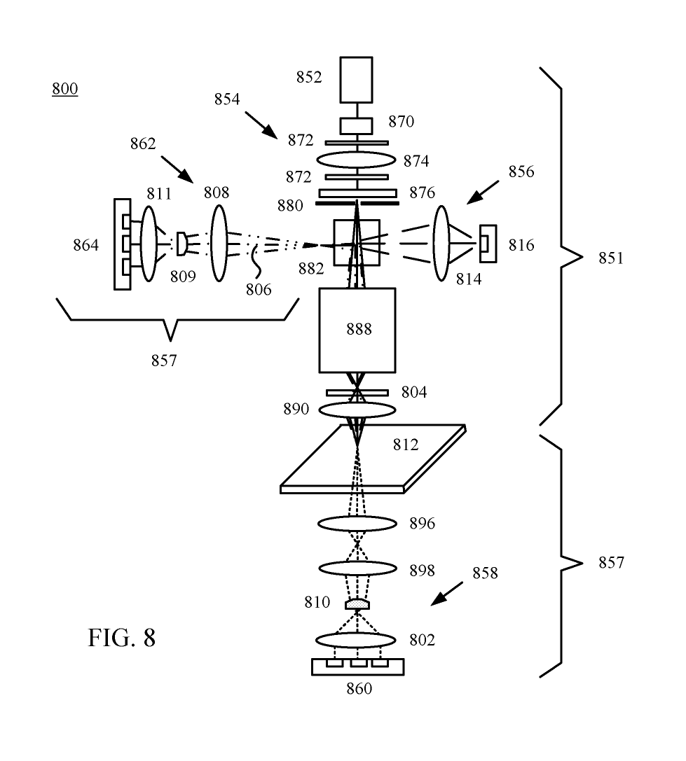

FIGS. 8-15 illustrate systems that can include the above-described laser systems using the OP modules for frequency conversions. These systems can be used in photomask, reticle, or wafer inspection applications.

FIG. 8 illustrates an exemplary optical inspection system 800 for inspecting the surface of a substrate 812. System 800 generally includes a first optical arrangement 851 and a second optical arrangement 857. As shown, first optical arrangement 851 includes at least a light source 852, inspection optics 854, and reference optics 856, while the second optical arrangement 857 includes at least transmitted light optics 858, transmitted light detectors 860, reflected light optics 862, and reflected light detectors 864. In one preferred configuration, light source 852 includes one of the above-described improved lasers.

Light source 852 is configured to emit a light beam that passes through an acousto-optic device 870, which is arranged for deflecting and focusing the light beam. Acousto-optic device 870 may include a pair of acousto-optic elements, e.g. an acousto-optic pre-scanner and an acousto-optic scanner, which deflect the light beam in the Y-direction and focus it in the Z-direction. By way of example, most acousto-optic devices operate by sending an RF signal to quartz or a crystal such as TeO₂. This RF signal causes a sound wave to travel through the crystal. Because of the travelling sound wave, the crystal becomes asymmetric, which causes the index of refraction to change throughout the crystal. This change causes incident beams to form a focused travelling spot which is deflected in an oscillatory fashion.

When the light beam emerges from acousto-optic device 870, it then passes through a pair of quarter wave plates 872 and a relay lens 874. Relay lens 874 is arranged to collimate the light beam. The collimated light beam then continues on its path until it reaches a diffraction grating 876. Diffraction grating 876 is arranged for flaring out the light beam, and more particularly for separating the light beam into three distinct beams, which are spatially distinguishable from one another (i.e. spatially distinct). In most cases, the spatially distinct beams are also arranged to be equally spaced apart and have substantially equal light intensities.

Upon leaving the diffraction grating 876, the three beams pass through an aperture 880 and then continue until they reach a beam splitter cube 882. Beam splitter cube 882 (in combination with the quarter wave plates 872) is arranged to divide the beams into two paths, i.e. one directed downward and the other directed to the right (in the configuration shown in FIG. 8). The path directed downward is used to distribute a first light portion of the beams to substrate 812, whereas the path directed to the right is used to distribute a second light portion of the beams to reference optics 856. In most embodiments, most of the light is distributed to substrate 812 and a small percentage of the light is distributed to reference optics 856, although the percentage ratios may vary according to the specific design of each optical inspection system. In one embodiment, reference optics 856 can include a reference collection lens 814 and a reference detector 816. Reference collection lens 814 is arranged to collect and direct the portion of the beams on reference detector 816, which is arranged to measure the intensity of the light. Reference optics are generally well known in the art and for the sake of brevity will not be discussed in detail.

The three beams directed downward from beam splitter 882 are received by a telescope 888, which includes several lens elements that redirect and expand the light. In one embodiment, telescope 888 is part of a telescope system that includes a plurality of telescopes rotating on a turret. For example, three telescopes may be used. The purpose of these telescopes is to vary the size of the scanning spot on the substrate and thereby allow selection of the minimum detectable defect size. More particularly, each of the telescopes generally represents a different pixel size. As such, one telescope may generate a larger spot size making the inspection faster and less sensitive (e.g., low resolution), while another telescope may generate a smaller spot size making inspection slower and more sensitive (e.g., high resolution).

From telescope 888, the three beams pass through an objective lens 890, which is arranged for focusing the beams onto the surface of substrate 812. As the beams intersect the surface as three distinct spots, both reflected light beams and transmitted light beams may be generated. The transmitted light beams pass through substrate 812, while the reflected light beams reflect off the surface. By way of example, the reflected light beams may reflect off of opaque surfaces of the substrate, and the transmitted light beams may transmit through transparent areas of the substrate. The transmitted light beams are collected by transmitted light optics 858 and the reflected light beams are collected by reflected light optics 862.

With regards to transmitted light optics 858, the transmitted light beams, after passing through substrate 812, are collected by a first transmitted lens 896 and focused with the aid of a spherical aberration corrector lens 898 onto a transmitted prism 810. Prism 810 can be configured to have a facet for each of the transmitted light beams that are arranged for repositioning and bending the transmitted light beams. In most cases, prism 810 is used to separate the beams so that they each fall on a single detector in transmitted light detector arrangement 860 (shown as having three distinct detectors). Accordingly, when the beams leave prism 810, they pass through a second transmitted lens 802, which individually focuses each of the separated beams onto one of the three detectors, each of which is arranged for measuring the intensity of the transmitted light.

With regards to reflected light optics 862, the reflected light beams after reflecting off of substrate 812 are collected by objective lens 890, which then directs the beams towards telescope 888. Before reaching telescope 888, the beams also pass through a quarter wave plate 804. In general terms, objective lens 890 and telescope 888 manipulate the collected beams in a manner that is optically reverse in relation to how the incident beams are manipulated. That is, objective lens 890 re-collimates the beams, and telescope 888 reduces their size. When the beams leave telescope 888, they continue (backwards) until they reach beam splitter cube 882. Beam splitter 882 is configured to work with quarter wave-plate 804 to direct the beams onto a central path 806.

The beams continuing on path 806 are then collected by a first reflected lens 808, which focuses each of the beams onto a reflected prism 809, which includes a facet for each of the reflected light beams. Reflected prism 809 is arranged for repositioning and bending the reflected light beams. Similar to transmitted prism 810, reflected prism 809 is used to separate the beams so that they each fall on a single detector in the reflected light detector arrangement 864. As shown, reflected light detector arrangement 864 includes three individually distinct detectors. When the beams leave reflected prism 809, they pass through a second reflected lens 811, which individually focuses each of the separated beams onto one of these detectors, each of which is arranged for measuring the intensity of the reflected light.

There are multiple inspection modes that can be facilitated by the aforementioned optical assembly. By way of example, the optical assembly can facilitate a transmitted light inspection mode, a reflected light inspection mode, and a simultaneous inspection mode. With regards to the transmitted light inspection mode, transmission mode detection is typically used for defect detection on substrates such as conventional optical masks having transparent areas and opaque areas. As the light beams scan the mask (or substrate 812), the light penetrates the mask at transparent points and is detected by the transmitted light detectors 860, which are located behind the mask and which measure the intensity of each of the light beams collected by transmitted light optics 858 including first transmitted lens 896, second transmitted lens 802, spherical aberration lens 898, and prism 810.

With regards to the reflected light inspection mode, reflected light inspection can be performed on transparent or opaque substrates that contain image information in the form of chromium, developed photoresist or other features. Light reflected by the substrate 812 passes backwards along the same optical path as inspection optics 854, but is then diverted by a polarizing beam splitter 882 into detectors 864. More particularly, first reflected lens 808, prism 809, and second reflected lens 811 project the light from the diverted light beams onto detectors 864. Reflected light inspection may also be used to detect contamination on top of opaque substrate surfaces.

With regards to the simultaneous inspection mode, both transmitted light and reflected light are utilized to determine the existence and/or type of a defect. The two measured values of the system are the intensity of the light beams transmitted through substrate 812 as sensed by transmitted light detectors 860 and the intensity of the reflected light beams as detected by reflected light detectors 864. Those two measured values can then be processed to determine the type of defect, if any, at a corresponding point on substrate 812.

More particularly, simultaneous transmitted and reflected detection can disclose the existence of an opaque defect sensed by the transmitted detectors while the output of the reflected detectors can be used to disclose the type of defect. As an example, either a chrome dot or a particle on a substrate may both result in a low transmitted light indication from the transmission detectors, but a reflective chrome defect may result in a high reflected light indication and a particle may result in a lower reflected light indication from the same reflected light detectors. Accordingly, by using both reflected and transmitted detection one may locate a particle on top of chrome geometry which could not be done if only the reflected or transmitted characteristics of the defect were examined. In addition, one may determine signatures for certain types of defects, such as the ratio of their reflected and transmitted light intensities. This information can then be used to automatically classify defects. U.S. Pat. No. 5,563,702, which issued on Oct. 8, 1996 and is incorporated by reference herein, describes additional details regarding system 800.

In accordance with certain embodiments of the present invention an inspection system that incorporates an approximately 193 nm laser system may simultaneously detect two channels of data on a single detector. Such an inspection system may be used to inspect a substrate such as a reticle, a photomask or a wafer, and may operate as described in U.S. Pat. No. 7,528,943, which issued on May 5, 2009 to Brown et al, and is incorporated by reference herein.

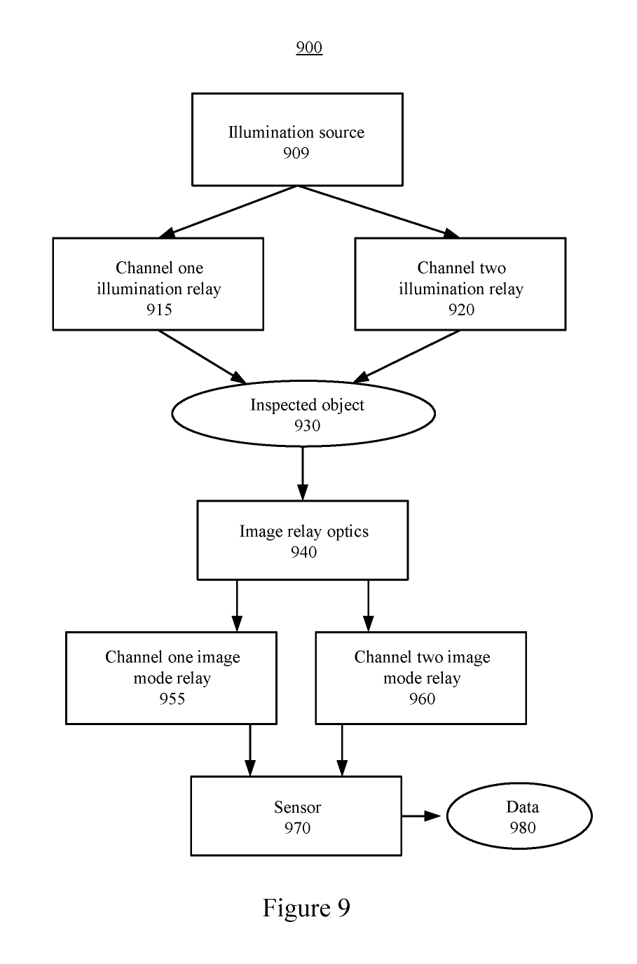

FIG. 9 shows a reticle, photomask or wafer inspection system 900 that simultaneously detects two channels of image or signal on one sensor 970. The illumination source 909 incorporates a 193 nm laser system as described herein. The light source may further comprise a pulse multiplier and/or a coherence reducing scheme. The two channels may comprise reflected and transmitted intensity when an inspected object 930 is transparent (for example a reticle or photomask), or may comprise two different illumination modes, such as angles of incidence, polarization states, wavelength ranges or some combination thereof.

As shown in FIG. 9, illumination relay optics 915 and 920 relay the illumination from source 909 to the inspected object 930. The inspected object 930 may be a reticle, a photomask, a semiconductor wafer or other article to be inspected. Image relay optics 955 and 960 relay the light that is reflected and/or transmitted by the inspected object 930 to the sensor 970. The data corresponding to the detected signals or images for the two channels is shown as data 980 and is transmitted to a computer (not shown) for processing.

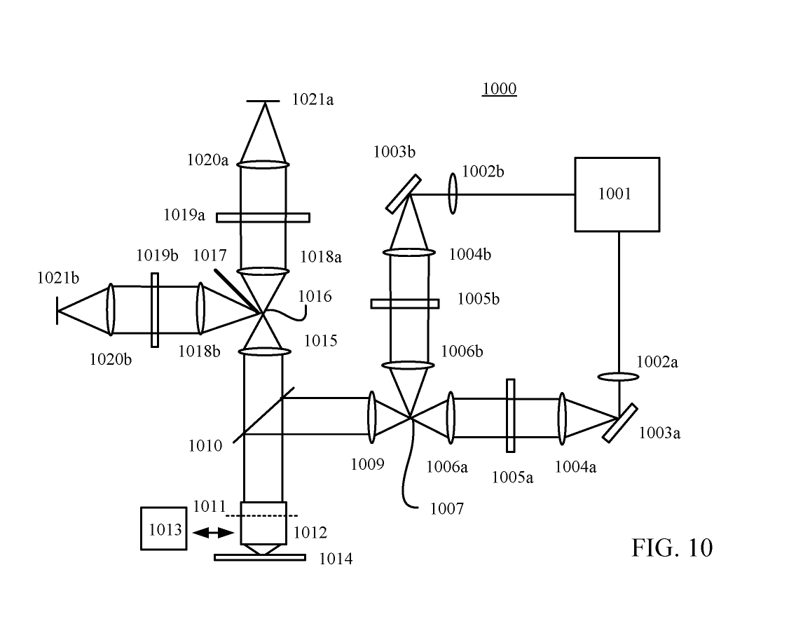

FIG. 10 illustrates an exemplary inspection system 1000 including multiple objectives and one of the above-described improved lasers. In system 1000, illumination from a laser source 1001 is sent to multiple sections of the illumination subsystem. A first section of the illumination subsystem includes elements 1002a through 1006a. Lens 1002a focuses light from laser 1001. Light from lens 1002a then reflects from mirror 1003a. Mirror 1003a is placed at this location for the purposes of illustration, and may be positioned elsewhere. Light from mirror 1003a is then collected by lens 1004a, which forms illumination pupil plane 1005a. An aperture, filter, or other device to modify the light may be placed in pupil plane 1005a depending on the requirements of the inspection mode. Light from pupil plane 1005a then passes through lens 1006a and forms illumination field plane 1007.

A second section of the illumination subsystem includes elements 1002b through 1006b. Lens 1002b focuses light from laser 1001. Light from lens 1002b then reflects from mirror 1003b. Light from mirror 1003b is then collected by lens 1004b which forms illumination pupil plane 1005b. An aperture, filter, or other device to modify the light may be placed in pupil plane 1005b depending on the requirements of the inspection mode. Light from pupil plane 1005b then passes through lens 1006b and forms illumination field plane 1007. The light from the second section is then redirected by mirror or reflective surface such that the illumination field light energy at illumination field plane 1007 is comprised of the combined illumination sections.

Field plane light is then collected by lens 1009 before reflecting off a beamsplitter 1010. Lenses 1006a and 1009 form an image of first illumination pupil plane 1005a at objective pupil plane 1011. Likewise, lenses 1006b and 1009 form an image of second illumination pupil plane 1005b at objective pupil plane 1011. An objective 1012 (or alternatively 1013) then takes the pupil light and forms an image of illumination field 1007 at sample 1014. Objective 1012 or objective 1013 can be positioned in proximity to sample 1014. Sample 1014 can move on a stage (not shown), which positions the sample in the desired location. Light reflected and scattered from the sample 1014 is collected by the high NA catadioptric objective 1012 or objective 1013. After forming a reflected light pupil at objective pupil plane 1011, light energy passes beamsplitter 1010 and lens 1015 before forming an internal field 1016 in the imaging subsystem. This internal imaging field is an image of sample 1014 and correspondingly illumination field 1007. This field may be spatially separated into multiple fields corresponding to the illumination fields. Each of these fields can support a separate imaging mode.

One of these fields can be redirected using mirror 1017. The redirected light then passes through lens 1018b before forming another imaging pupil 1019b. This imaging pupil is an image of pupil 1011 and correspondingly illumination pupil 1005b. An aperture, filter, or other device to modify the light may be placed in pupil plane 1019b depending on the requirements of the inspection mode. Light from pupil plane 1019b then passes through lens 1020b and forms an image on sensor 1021b. In a similar manner, light passing by mirror or reflective surface 1017 is collected by lens 1018a and forms imaging pupil 1019a. Light from imaging pupil 1019a is then collected by lens 1020a before forming an image on detector 1021a. Light imaged on detector 1021a can be used for a different imaging mode from the light imaged on sensor 1021b.

The illumination subsystem employed in system 1000 is composed of laser source 1001, collection optics 1002-1004, beam shaping components placed in proximity to a pupil plane 1005, and relay optics 1006 and 1009. An internal field plane 1007 is located between lenses 1006 and 1009. In one preferred configuration, laser source 901 can include one of the above-described improved lasers.

With respect to laser source 1001, while illustrated as a single uniform block having two points or angles of transmission, in reality this represents a laser source able to provide two channels of illumination, for example a first channel of light energy such as laser light energy at a first frequency which passes through elements 1002a-1006a, and a second channel of light energy such as laser light energy at a second frequency which passes through elements 1002b-1006b. Different light energy modes may be employed, such as bright field energy in one channel and a dark field mode in the other channel.

While light energy from laser source 1001 is shown to be emitted 90 degrees apart, and the elements 1002a-1006a and 1002b-1006b are oriented at 90 degree angles, in reality light may be emitted at various orientations, not necessarily in two dimensions, and the components may be oriented differently than as shown. FIG. 10 is therefore simply a representation of the components employed and the angles or distances shown are not to scale nor specifically required for the design.

Elements placed in proximity to pupil plane 1005 may be employed in the current system using the concept of aperture shaping. Using this design, uniform illumination or near uniform illumination may be realized, as well as individual point illumination, ring illumination, quadrapole illumination, or other desirable patterns.

Various implementations for the objectives may be employed in a general imaging subsystem. A single fixed objective may be used. The single objective may support all the desired imaging and inspection modes. Such a design is achievable if the imaging system supports a relatively large field size and relatively high numerical aperture. Numerical aperture can be reduced to a desired value by using internal apertures placed at the pupil planes 1005a, 1005b, 1019a, and 1019b.

Multiple objectives may also be used as shown in FIG. 10. For example, although two objectives 1012 and 1013 are shown, any number is possible. Each objective in such a design may be optimized for each wavelength produced by laser source 1001. These objectives 1012 and 1013 can either have fixed positions or be moved into position in proximity to the sample 1014. To move multiple objectives in proximity to the sample, rotary turrets may be used as are common on standard microscopes. Other designs for moving objectives in proximity of a sample are available, including but not limited to translating the objectives laterally on a stage, and translating the objectives on an arc using a goniometer. In addition, any combination of fixed objectives and multiple objectives on a turret can be achieved in accordance with the present system.

The maximum numerical apertures of this configuration may approach or exceed 0.97, but may in certain instances be higher. The wide range of illumination and collection angles possible with this high NA catadioptric imaging system, combined with its large field size allows the system to simultaneously support multiple inspection modes. As may be appreciated from the previous paragraphs, multiple imaging modes can be implemented using a single optical system or machine in connection with the illumination device. The high NA disclosed for illumination and collection permits the implementation of imaging modes using the same optical system, thereby allowing optimization of imaging for different types of defects or samples.

The imaging subsystem also includes intermediate image forming optics 1015. The purpose of the image forming optics 1015 is to form an internal image 1016 of sample 1014. At this internal image 1016, a mirror 1017 can be placed to redirect light corresponding to one of the inspection modes. It is possible to redirect the light at this location because the light for the imaging modes are spatially separate. The image forming optics 1018 (1018a and 1018b) and 1020 (1020a and 1020b) can be implemented in several different forms including a varifocal zoom, multiple afocal tube lenses with focusing optics, or multiple image forming mag tubes. U.S. Published Application 2009/0180176, which published on Jul. 16, 2009 and is incorporated by reference herein, describes additional details regarding system 1000.

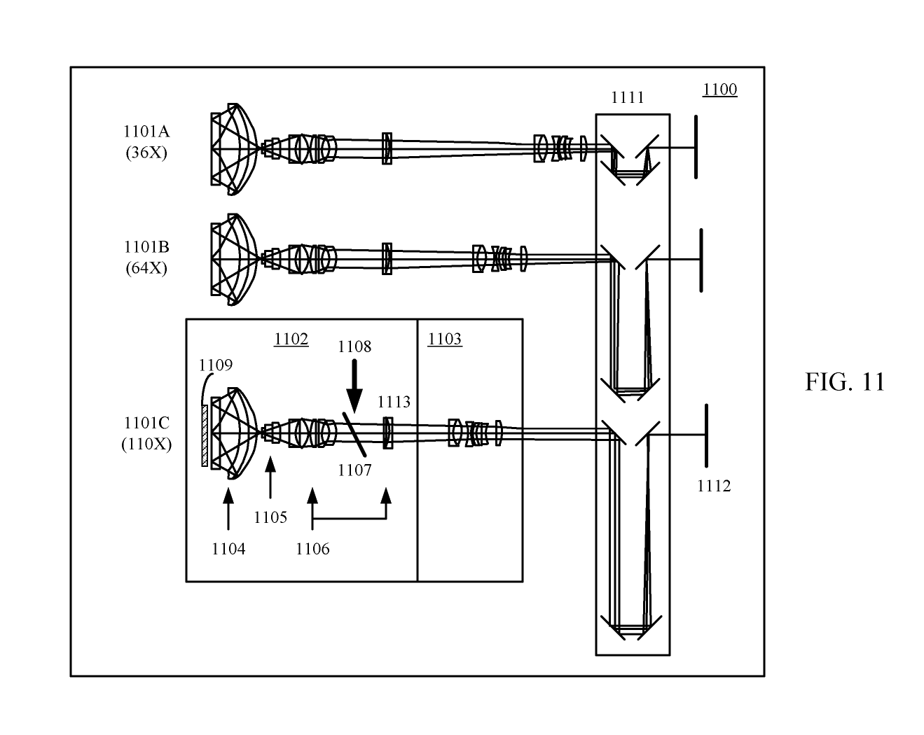

FIG. 11 illustrates an exemplary ultra-broadband UV microscope imaging system 1100 including three sub-sections 1101A, 1101B, and 1101C. Sub-section 1101C includes a catadioptric objective section 1102 and a zooming tube lens 1103. Catadioptric objective section 1102 includes a catadioptric lens group 1104, a field lens group 1105, and a focusing lens group 1106. System 1100 can image an object/sample 1109 (e.g. a wafer being inspected) to an image plane 1112.

Catadioptric lens group 1104 includes a near planar (or planar) reflector (which is a reflectively coated lens element), a meniscus lens (which is a refractive surface), and a concave spherical reflector. Both reflective elements can have central optical apertures without reflective material to allow light from an intermediate image plane to pass through the concave spherical reflector, be reflected by the near planar (or planar) reflector onto the concave spherical reflector, and pass back through the near planar (or planar) reflector, traversing the associated lens element or elements on the way. Catadioptric lens group 1104 is positioned to form a real image of the intermediate image, such that, in combination with zooming tube lens 1103, primary longitudinal color of the system is substantially corrected over the wavelength band.

Field lens group 1105 can be made from two or more different refractive materials, such as fused silica and fluoride glass, or diffractive surfaces. Field lens group 1105 may be optically coupled together or alternatively may be spaced slightly apart in air. Because fused silica and fluoride glass do not differ substantially in dispersion in the deep ultraviolet range, the individual powers of the several component element of the field lens group need to be of high magnitude to provide different dispersions. Field lens group 1105 has a net positive power aligned along the optical path proximate to the intermediate image. Use of such an achromatic field lens allows the complete correction of chromatic aberrations including at least secondary longitudinal color as well as primary and secondary lateral color over an ultra-broad spectral range. In one embodiment, only one field lens component need be of a refractive material different than the other lenses of the system.

Focusing lens group 1106 includes multiple lens elements, preferably all formed from a single type of material, with refractive surfaces having curvatures and positions selected to correct both monochromatic aberrations and chromatic variation of aberrations and focus light to an intermediate image. In one embodiment of focusing lens group 1106, a combination of lenses 1113 with low power corrects for chromatic variation in spherical aberration, coma, and astigmatism. A beam splitter 1107 provides an entrance for a UV light source 1108. UV light source 1108 can advantageously be implemented by the improved laser described above.

Zooming tube lens 1103 can be all the same refractive material, such as fused silica, and is designed so that primary longitudinal and primary lateral colors do not change during zooming. These primary chromatic aberrations do not have to be corrected to zero, and cannot be if only one glass type is used, but they have to be stationary, which is possible. Then the design of the catadioptric objective section 1102 must be modified to compensate for these uncorrected but stationary chromatic aberrations of zooming tube lens 1103. Zooming tube lens 1103, which can zoom or change magnification without changing its higher-order chromatic aberrations, includes lens surfaces disposed along an optical path of the system.

In one preferred embodiment, zooming tube lens 1003 is first corrected independently of catadioptric objective 1102 section using two refractive materials (such as fused silica and calcium fluoride). Zooming tube lens 1103 is then combined with catadioptric objective section 1102, at which time catadioptric objective section 1102 can be modified to compensate for the residual higher-order chromatic aberrations of system 1100. This compensating is possible because of field lens group 1105 and low power lens group 1113. The combined system is then optimized with all parameters being varied to achieve the best performance.

Note that sub-sections 1101A and 1101B include substantially similar components to that of sub-section 1201C and therefore are not discussed in detail.

System 1100 includes a folding mirror group 1111 to provide linear zoom motion that allows a zoom from 36× to 100×. The wide range zoom provides continuous magnification change, whereas the fine zoom reduces aliasing and allows electronic image processing, such as cell-to-cell subtraction for a repeating image array. Folding mirror group 1111 can be characterized as a “trombone” system of reflective elements. Zooming is done by moving the group of zooming tube lens 1103, as a unit, and also moving the arm of the trombone slide. Because the trombone motion only affects focus and the f# speed at its location is very slow, the accuracy of this motion could be very loose. One advantage of this trombone configuration is that it significantly shortens the system. Another advantage is that there is only one zoom motion that involves active (non-flat) optical elements. And the other zoom motion, with the trombone slide, is insensitive to errors. U.S. Pat. No. 5,999,310, which issued on Dec. 7, 1999 and is incorporated by reference herein, describes system 1100 in further detail.

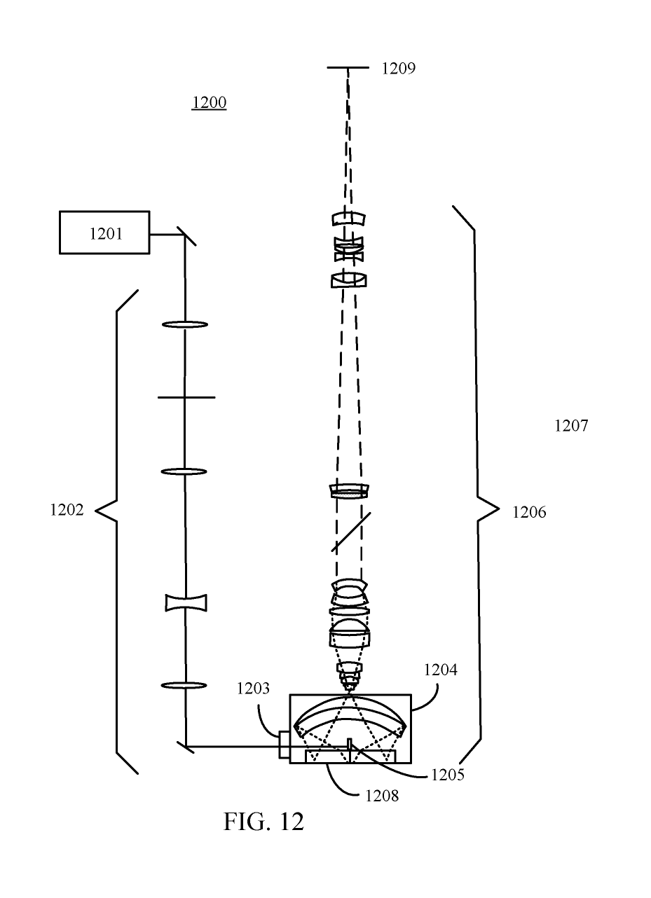

FIG. 12 illustrates the addition of a normal incidence laser illumination (dark-field or bright-field) to a catadioptric imaging system 1200. The illumination block of system 1200 includes a laser 1201, adaptation optics 1202 to control the illumination beam size and profile on the surface being inspected, an aperture and window 1203 in a mechanical housing 1204, and a prism 1205 to redirect the laser along the optical axis at normal incidence to the surface of a sample 1208. Prism 1205 also directs the specular reflection from surface features of sample 1208 and reflections from the optical surfaces of an objective 1206 along the optical path to an image plane 1209. Lenses for objective 1206 can be provided in the general form of a catadioptric objective, a focusing lens group, and a zooming tube lens section (see, e.g. FIG. 11). In a preferred embodiment, laser 1201 can be implemented by the above-described improved laser. Published Patent Application 2007/0002465, which published on Jan. 4, 2007 and is incorporated by reference herein, describes system 1200 in further detail.

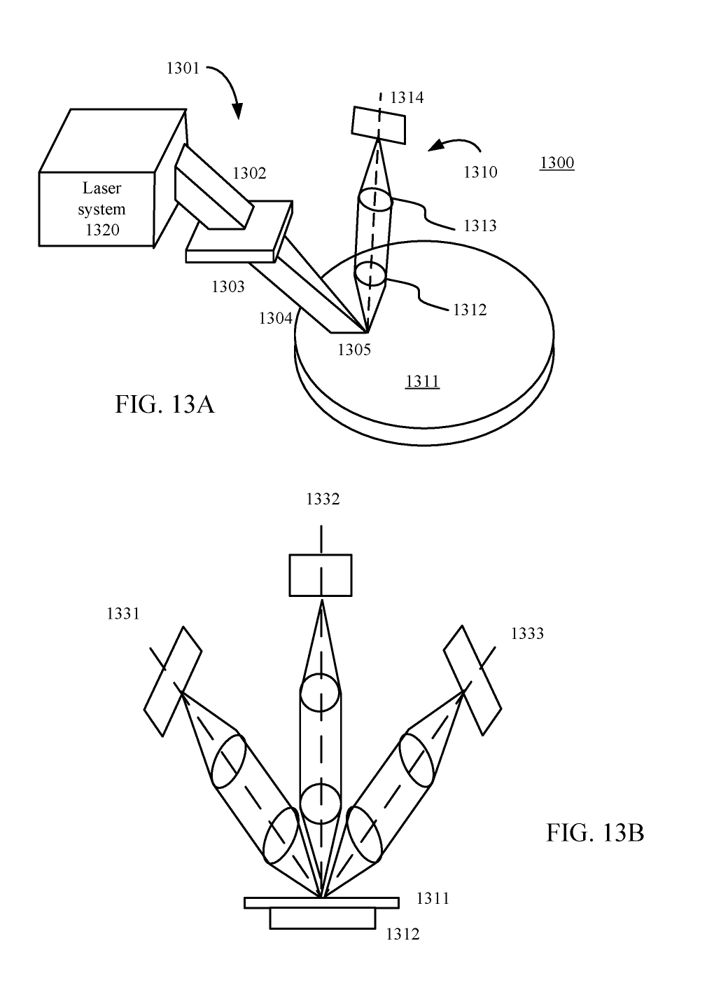

FIG. 13A illustrates a surface inspection apparatus 1300 that includes illumination system 1301 and collection system 1310 for inspecting areas of surface 1311. As shown in FIG. 13A, a laser system 1320 directs a light beam 1302 through a lens 1303. In a preferred embodiment, laser system 1320 includes the above-described improved laser, an annealed crystal, and a housing to maintain the annealed condition of the crystal during standard operation at a low temperature. First beam shaping optics can be configured to receive a beam from the laser and focus the beam to an elliptical cross section at a beam waist in or proximate to the crystal.

Lens 1303 is oriented so that its principal plane is substantially parallel to a sample surface 1311 and, as a result, illumination line 1305 is formed on surface 1311 in the focal plane of lens 1303. In addition, light beam 1302 and focused beam 1304 are directed at a non-orthogonal angle of incidence to surface 1311. In particular, light beam 1302 and focused beam 1304 may be directed at an angle between about 1 degree and about 85 degrees from a normal direction to surface 1311. In this manner, illumination line 1305 is substantially in the plane of incidence of focused beam 1304.

Collection system 1310 includes lens 1312 for collecting light scattered from illumination line 1305 and lens 1313 for focusing the light coming out of lens 1312 onto a device, such as charge coupled device (CCD) 1314, comprising an array of light sensitive detectors. In one embodiment, CCD 1314 may include a linear array of detectors. In such cases, the linear array of detectors within CCD 1314 can be oriented parallel to illumination line 1315. In one embodiment, multiple collection systems can be included, wherein each of the collection systems includes similar components, but differ in orientation.

For example, FIG. 13B illustrates an exemplary array of collection systems 1331, 1332, and 1333 for a surface inspection apparatus (wherein its illumination system, e.g. similar to that of illumination system 1301, is not shown for simplicity). First optics in collection system 1331 collect light scattered in a first direction from the surface of sample 1311. Second optics in collection system 1332 collect light scattered in a second direction from the surface of sample 1311. Third optics in collection system 1333 collect light scattered in a third direction from the surface of sample 1311. Note that the first, second, and third paths are at different angles of reflection to said surface of sample 1311. A platform 1312 supporting sample 1311 can be used to cause relative motion between the optics and sample 1311 so that the whole surface of sample 1311 can be scanned. U.S. Pat. No. 7,525,649, which issued on Apr. 28, 2009 and is incorporated by reference herein, describes surface inspection apparatus 1300 and other multiple collection systems in further detail.

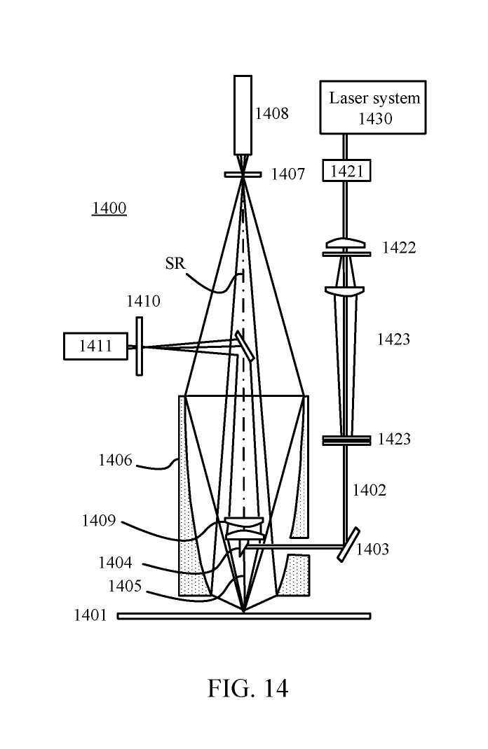

FIG. 14 illustrates a surface inspection system 1400 that can be used for inspecting anomalies on a surface 1401. In this embodiment, surface 1401 can be illuminated by a substantially stationary illumination device portion of a laser system 1430 comprising a laser beam generated by the above-described improved laser. The output of laser system 1430 can be consecutively passed through polarizing optics 1421, a beam expander and aperture 1422, and beam-forming optics 1423 to expand and focus the beam.

The resulting focused laser beam 1402 is then reflected by a beam folding component 1403 and a beam deflector 1404 to direct the beam 1405 towards surface 1401 for illuminating the surface. In the preferred embodiment, beam 1405 is substantially normal or perpendicular to surface 1401, although in other embodiments beam 1405 may be at an oblique angle to surface 1401.

In one embodiment, beam 1405 is substantially perpendicular or normal to surface 1401 and beam deflector 1404 reflects the specular reflection of the beam from surface 1401 towards beam turning component 1403, thereby acting as a shield to prevent the specular reflection from reaching the detectors. The direction of the specular reflection is along line SR, which is normal to the surface 1401 of the sample. In one embodiment where beam 1405 is normal to surface 1401, this line SR coincides with the direction of illuminating beam 1405, where this common reference line or direction is referred to herein as the axis of inspection system 1400. Where beam 1405 is at an oblique angle to surface 1401, the direction of specular reflection SR would not coincide with the incoming direction of beam 1405; in such instance, the line SR indicating the direction of the surface normal is referred to as the principal axis of the collection portion of inspection system 1400.

Light scattered by small particles are collected by mirror 1406 and directed towards aperture 1407 and detector 1408. Light scattered by large particles are collected by lenses 1409 and directed towards aperture 1410 and detector 1411. Note that some large particles will scatter light that is also collected and directed to detector 1408, and similarly some small particles will scatter light that is also collected and directed to detector 1411, but such light is of relatively low intensity compared to the intensity of scattered light the respective detector is designed to detect. In one embodiment, detector 1411 can include an array of light sensitive elements, wherein each light sensitive element of the array of light sensitive elements is configured to detect a corresponding portion of a magnified image of the illumination line. In one embodiment, inspection system can be configured for use in detecting defects on unpatterned wafers. U.S. Pat. No. 6,271,916, which issued on Aug. 7, 2001 and is incorporated by reference herein, describes inspection system 1400 in further detail.

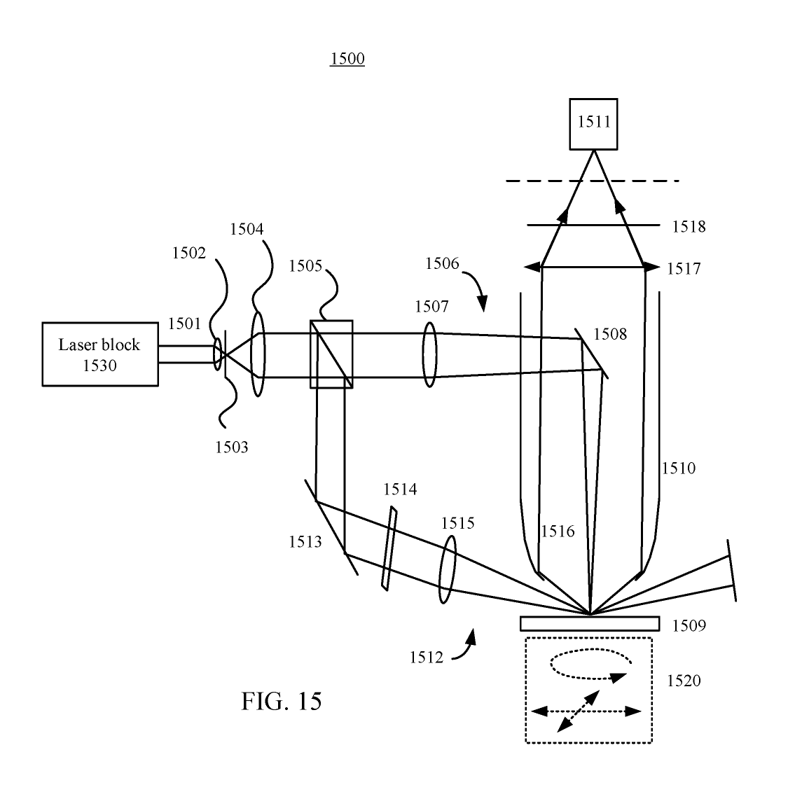

FIG. 15 illustrates an inspection system 1500 configured to implement anomaly detection using both normal and oblique illumination beams. In this configuration, a laser system 1530, which includes the above-described improved laser, can provide a laser beam 1501. A lens 1502 focuses the beam 1501 through a spatial filter 1503 and lens 1504 collimates the beam and conveys it to a polarizing beam splitter 1505. Beam splitter 1505 passes a first polarized component to the normal illumination channel and a second polarized component to the oblique illumination channel, where the first and second components are orthogonal. In the normal illumination channel 1506, the first polarized component is focused by optics 1507 and reflected by mirror 1508 towards a surface of a sample 1509. The radiation scattered by sample 1509 is collected and focused by a paraboloidal mirror 1510 to a photomultiplier tube 1511.

In the oblique illumination channel 1512, the second polarized component is reflected by beam splitter 1505 to a mirror 1513 which reflects such beam through a half-wave plate 1514 and focused by optics 1515 to sample 1509. Radiation originating from the oblique illumination beam in the oblique channel 1512 and scattered by sample 1509 is also collected by paraboloidal mirror 1510 and focused to photomultiplier tube 1511. Note that photomultiplier tube 1511 has a pinhole entrance. The pinhole and the illuminated spot (from the normal and oblique illumination channels on surface 1509) are preferably at the foci of the paraboloidal mirror 1510.

The paraboloidal mirror 1510 collimates the scattered radiation from sample 1509 into a collimated beam 1516. Collimated beam 1516 is then focused by an objective 1517 and through an analyzer 1518 to the photomultiplier tube 1511. Note that curved mirrored surfaces having shapes other than paraboloidal shapes may also be used. An instrument 1520 can provide relative motion between the beams and sample 1509 so that spots are scanned across the surface of sample 1509. U.S. Pat. No. 6,201,601, which issued on Mar. 13, 2001 and is incorporated by reference herein, describes inspection system 1500 in further detail.

Other reticle, photomask, or wafer inspection systems can advantageously use the above-described improved laser. For example, other systems include those described in U.S. Pat. Nos. 5,563,702, 5,999,310, 6,201,601, 6,271,916, 7,352,457, 7,525,649, and 7,528,943. Yet further systems include those described in US Publications: 2007/0002465 and 2009/0180176. When used in an inspection system, this improved laser may advantageously be combined with the coherence and speckle reducing apparatus and methods disclosed in published PCT application WO 2010/037106 and U.S. patent application Ser. No. 13/073,986. This improved laser may also be advantageously combined with the methods and systems disclosed in U.S. Provisional Application 61/496,446, entitled “Optical peak power reduction of laser pulses and semiconductor and metrology systems using same”, filed on Jun. 13, 2011, and in U.S. patent application Ser. No. 13/487,075, entitled “Semiconductor Inspection And Metrology System Using Laser Pulse Multiplier”, filed on Jun. 1, 2012 and now published as U.S. Publication 2012/0314286 on Dec. 13, 2012. The patents, patent publications, and patent applications cited in this paragraph are incorporated by reference herein.

Although some of the above embodiments describe an approximately 1063.5 nm fundamental wavelength being converted into an output wavelength of approximately 193.368 nm, it is to be understood that other wavelengths within a few nm of 193.368 nm could be generated by this approach using an appropriate choice of fundamental wavelength and signal wavelength. Such lasers and systems utilizing such lasers are within the scope of this invention.

The improved laser will be significantly less expensive than an 8^{th}-harmonic laser and have longer life, thereby providing better cost of ownership compared to an 8^{th} harmonic laser. Note that fundamental lasers operating near 1064 nm are readily available at a reasonable price in various combinations of power and repetition rate. Indeed, the improved laser can be constructed in its entirety using components that are readily available and relatively inexpensive. Because the improved laser can be a high-repetition-rate mode-locked or Q-switched laser, the improved laser can simplify the illumination optics of the reticle/photomask/wafer inspection system compared with a low repetition rate laser.

The various embodiments of the structures and methods of this invention that are described above are illustrative only of the principles of this invention and are not intended to limit the scope of the invention to the particular embodiments described.

For example, instead of generating a wavelength that is exactly double the fundamental wavelength, a wavelength can be generated to be shifted from twice the fundamental wavelength by approximately 10 nm, 20 nm or a few hundred nm. By using a wavelength that is not exactly twice the fundamental wavelength, it is possible to generate an output wavelength that is slightly shifted from the fundamental wavelength divided by 5.5. For example, the fundamental wavelength divided by a value between approximately 5.4 and 5.6, or in some embodiments, the fundamental wavelength divided by a value between 5.49 and 5.51. Some embodiments down convert the second harmonic frequency of the fundamental to generate the frequencies that are approximately half the fundamental frequency and approximately 1.5 times the fundamental frequency. Thus, the invention is limited only by the following claims and their equivalents.

1. An optical inspection system for inspecting a surface of a photomask, reticle, or semiconductor wafer for defects, the system comprising:
a light source configured to emit an incident light beam along an optical axis, the light source including a fundamental laser for generating a fundamental frequency having a corresponding wavelength of approximately 1064 nm, an optical parametric (OP) module configured to down convert the fundamental frequency and to generate an OP output having a frequency approximately equal to a half harmonic of the fundamental frequency, a fifth harmonic generator module configured to generate a fifth harmonic frequency, and a frequency mixing module configured to receive and combine the fifth harmonic frequency and the OP output to generate a laser output with the approximately 193.368 nm wavelength light;
an optical system disposed along the optical axis and including a plurality of optical components for directing the incident light beam to a surface of the photomask, reticle or semiconductor wafer, the optical system being configured to scan the surface;
a transmitted light detector arrangement including transmitted light detectors, the transmitted light detectors being arranged for sensing a light intensity of transmitted light; and
a reflected light detector arrangement including reflected light detectors, the reflected light detectors being arranged for sensing a light intensity of reflected light,
wherein the fundamental laser comprises one of neodymium-doped yttrium aluminum garnate, neodymium-doped yttrium orthovanadate, and a neodymium-doped mixture of gadolinium vanadate and yttrium vanadate.

2. The optical inspection system of claim 1, wherein the fundamental laser includes one of a Q-switched, mode-locked, and a continuous wave (CW) laser.

3. The optical inspection system of claim 1, wherein the OP module includes a seed laser that generates light of approximately 2127 nm wavelength or approximately 2109.7 nm wavelength.

4. The optical inspection system of claim 1, wherein the OP module includes a laser diode or a fiber laser.

5. The optical inspection system of claim 1, wherein the fifth harmonic generator module includes:
a second harmonic generator configured to double the fundamental frequency and generate a second harmonic frequency;
a fourth harmonic generator configured to double the second harmonic frequency and generate a fourth harmonic frequency; and
a fifth harmonic generator configured to combine the fourth harmonic frequency and an unconsumed fundamental frequency of the second harmonic generator to generate the fifth harmonic frequency.

6. The optical inspection system of claim 1, wherein the fifth harmonic generator module includes:
a second harmonic generator configured to double the fundamental frequency and generate a second harmonic frequency;
a third harmonic generator configured to combine the second harmonic frequency and an unconsumed fundamental frequency of the second harmonic generator to generate a third harmonic frequency; and
a fifth harmonic generator configured to combine the third harmonic frequency and an unconsumed second harmonic frequency of the third harmonic generator to generate the fifth harmonic frequency.

7. The optical inspection system of claim 5, wherein at least one of the second harmonic generator, the fourth harmonic generator, the fifth harmonic generator and the frequency mixing module comprises a hydrogen-annealed cesium lithium borate (CLBO) crystal.

8. The optical inspection system of claim 5,
wherein at least one of the fourth harmonic generator, the fifth harmonic generator, and the frequency mixing module comprises a non-linear optical crystal, and
wherein said one of the fourth harmonic generator, the fifth harmonic generator and the frequency mixing module further includes an optical component configured to focus the beam waist of an input beam to a substantially elliptical cross section inside or proximate to the non-linear optical crystal.

9. An inspection system for inspecting a surface of a sample, the inspection system comprising:
an illumination subsystem configured to produce a plurality of channels of light, each channel of light produced having differing characteristics from at least one other channel of light, the illumination subsystem including a light source configured to emit an incident light beam of approximately 193.368 nm wavelength, the light source including a fundamental laser configured to generate a fundamental frequency having a corresponding wavelength of approximately 1064 nm, a fifth harmonic generator module configured to use the fundamental frequency to generate a fifth harmonic frequency, an optical parametric (OP) module configured to down convert an unconsumed fundamental frequency of the fifth harmonic generator module and to generate an OP output having a frequency approximately equal to a half harmonic of the fundamental frequency, and a frequency mixing module configured to receive and combine the fifth harmonic frequency and the OP output to generate the incident light beam with the approximately 193.368 nm wavelength light;
optics configured to receive the plurality of channels of light and combine the plurality of channels of light into a spatially separated combined light beam and direct the spatially separated combined light beam toward the sample; and
a data acquisition subsystem comprising at least one detector configured to detect reflected light from the sample,
wherein the data acquisition subsystem is configured to separate the reflected light into a plurality of received channels corresponding to the plurality of channels of light, and
wherein the fundamental laser comprises one of neodymium-doped yttrium aluminum garnate, neodymium-doped yttrium orthovanadate, and a neodymium doped mixture of gadolinium vanadate and yttrium vanadate.

10. The inspection system of claim 9, wherein the fundamental laser includes one of a Q-switched, mode-locked, and a continuous wave (CW) laser.

11. The inspection system of claim 9, wherein said fifth harmonic module includes:
a second harmonic generator configured to double the fundamental frequency and generate a second harmonic frequency;
a fourth harmonic generator configured to double the second harmonic frequency and generate a fourth harmonic frequency; and
a fifth harmonic generator configured to combine the fourth harmonic frequency and an unconsumed fundamental frequency of the second harmonic generator to generate the fifth harmonic frequency.

12. The inspection system of claim 9, wherein said fifth harmonic generator module includes:
a second harmonic generator configured to double the fundamental frequency and generate a second harmonic frequency;
a third harmonic generator configured to combine the second harmonic frequency and an unconsumed fundamental frequency of the second harmonic generator to generate a third harmonic frequency; and
a fifth harmonic generator configured to combine the third harmonic frequency and an unconsumed second harmonic frequency of the third harmonic generator to generate the fifth harmonic frequency.

13. The inspection system of claim 9, wherein the OP module includes a seed laser that generates light of approximately 2127 nm wavelength or approximately 2109.7 nm.

14. The inspection system of claim 9, wherein the OP module includes a laser diode or a fiber laser.

15. The inspection system of claim 11, wherein at least one of the second harmonic generator, the fourth harmonic generator, the fifth harmonic generator and the frequency mixing module comprises a hydrogen-annealed cesium lithium borate (CLBO) crystal.

16. The inspection system of claim 11,
wherein at least one of the fourth harmonic generator, the fifth harmonic generator, and the frequency mixing module comprises a non-linear optical crystal, and
wherein said one of the fourth harmonic generator, the fifth harmonic generator and the frequency mixing module further includes an optical component configured to focus the beam waist of an input beam to a substantially elliptical cross section inside or proximate to the non-linear optical crystal.

17. A catadioptric imaging system comprising:
an ultraviolet (UV) light source configured to generate UV light having an approximately 193.368 nm wavelength light, the UV light source including a fundamental laser configured to generate a fundamental frequency having a corresponding wavelength of approximately 1064 nm, a second harmonic generator module configured to double the fundamental frequency and generate a second harmonic frequency, an optical parametric (OP) module configured to down convert a portion of the second harmonic frequency and to generate an OP signal of approximately 1.5ω and an OP idler at approximately 0.5ω, wherein ω is the fundamental frequency, a fourth harmonic module configured to double another portion of the second harmonic frequency of the OP module and generate a fourth harmonic frequency, and a frequency mixing module configured to combine the fourth harmonic frequency and the OP signal to generate the UV light having the corresponding wavelength of approximately 193.368 nm;
adaptation optics;
an objective including a catadioptric objective, a focusing lens group, and a zooming tube lens section; and
a prism for directing the UV light along an optical axis at normal incidence to a surface of a sample and directing specular reflections from surface features of the sample as well as reflections from optical surfaces of the objective along an optical path to an imaging plane,
wherein the fundamental laser comprises a neodymium doped mixture of gadolinium vanadate and yttrium vanadate.

18. The catadioptric imaging system of claim 17, wherein the fundamental laser includes one of a Q-switched, mode-locked, and a continuous wave (CW) laser.

19. The catadioptric imaging system of claim 17, wherein the OP module includes a seed laser that generates light of approximately 2127 nm wavelength or approximately 2109.7 nm.

20. The catadioptric imaging system of claim 17, wherein the OP module includes a laser diode or a fiber laser.
